(19) United States
(12) Patent Application Publication
(10) Pub. No.: US 2016/0098334 A1
(43) Pub. Date: Apr. 7, 2016

(54) BENCHMARKING MOBILE DEVICES

(71) Applicant: GameBench Limited, Bristol (GB)

(72) Inventors: KARTHIK HARIHARAKRISHNAN, Bristol (GB); SRI KANNAN IYER, London (GB)

(73) Assignee: GameBench Limited, Bristol (GB)

(21) Appl. No.: 14/506,165

(22) Filed: Oct. 3, 2014

(51) Int. Cl. G06F 11/30

(52) U.S. Cl. CPC G06F 11/3013

(57) ABSTRACT

According to aspects of the invention there are provided methods and apparatus for monitoring, analysing and/or optimising the performance of a mobile device. The mobile device includes a memory with computer readable instructions stored thereon associated with a diagnostic application, which when executed on a processor, has a first level of permissions for accessing the mobile device, and associated with a performance monitoring component, which when executed on the processor, has a second level of permissions for accessing the mobile device. The diagnostic application and performance monitoring component communicate to retrieve performance-related data associated with execution of an application on the mobile device, where the performance-related data is accessible using the second level of permissions. The diagnostic application receives and stores performance related data from the performance monitoring component for analysing and/or optimising the performance of the mobile device executing the application.

### TECHNICAL FIELD

The present invention relates to methods and apparatus for monitoring and analysing the performance of a mobile device. In particular, methods and apparatus for monitoring, analysing and/or optimising the performance of a mobile device and/or applications executing on the mobile device.

### BACKGROUND

Benchmarking computing devices involves running one or more specific benchmarking programs on the computing device to assess the relative performance of the underlying computer hardware and/or software of the computing device. Benchmarking assesses the performance characteristics of computer hardware such as, for example, the floating point operation performance of a CPU, the frames-per-second of a graphics card, or any other measurable performance aspect. Benchmarks provide a method of comparing the performance of various subsystems across different chip/system architectures. However, conventional benchmarking programs are expensive specialist programs that are used only by Information Technology experts (e.g. reviewers for Personal Computer magazines) for assessing new computers or devices. In addition, some of the well-known benchmarking programs have standardized routines that can be “played” by manufacturers of new computers and devices into providing false indications of high performance.

The last few years has seen an explosion in the number of mobile devices being marketed to consumers or users. A mobile device may comprise or represent any portable computing device. Examples of mobile devices that may be used in certain embodiments of the described apparatus, methods and systems may be wireless devices such as mobile phones, terminals, smart phones, portable computing devices such as laptops, handheld devices, tablets, tablet computers, netbooks, phablets, personal digital assistants, music players, satellite phones, and other wireless communication or computing devices.

Not only has the number of mobile devices surpassed the world's population, but such devices have become ever more powerful and feature rich. However, users of mobile devices now have to contend with the plethora of different types of mobile devices from manufacturers each claiming to be the best, fastest, and easiest to use. In order to make such claims, manufacturers and mobile device reviewers use specialised benchmarking programs to make an assessment on which device is best under various situations. However, given the different types of benchmarking programs, it is all too common to see contradictory mobile device reviews from different reviewers. Such reviews only make matters worse for consumers when deciding which mobile device to purchase.

Currently, there was no way for a user of a mobile device or potential user of a mobile device to objectively measure the performance the mobile device when executing real-world programs and applications (e.g. games, graphics intensive programs such as photo/video/audio programs, or spread sheet programs etc.). Neither is there a way for a user of a mobile device to objectively measure the performance of real-world applications executing on their mobile device. Such information is necessary for users to make informed decisions when purchasing a mobile device, to compare a set of mobile devices against real-world applications, compare a set of one or more applications against real-world mobile devices, and/or to maximise the potential performance and security of their mobile device.

Therefore, there is a need for improved methods, apparatus and systems to allow users to benchmark their own mobile devices and/or applications executing on the mobile device, optimising the performance of their mobile device and protecting a mobile device from the plethora of applications available for download and execution on the mobile device. Additionally, there is a need for an improved method, apparatus and system for enabling users to assess the real-world performance of their mobile devices and applications.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to an embodiment, there are provided methods and apparatus for monitoring, analysing and/or optimising the performance of a mobile device. The mobile device includes a memory with computer readable instructions stored thereon associated with a diagnostic application, which when executed on a processor of the mobile device, has a first level of permissions for accessing the mobile device, and associated with a performance monitoring component, which when executed on the processor, has a second level of permissions for accessing the mobile device. The diagnostic application and performance monitoring component communicate to retrieve performance-related data associated with execution of an application on the mobile device, where the performance-related data is accessible using the second level of permissions. The diagnostic application receives and stores performance related data from the performance monitoring component for analysing and/or optimising the performance of the mobile device executing the application.

In an embodiment, there is provided a computer-implemented method for monitoring and/or optimising the performance of a mobile device. The mobile device comprising a memory and a processor, the memory including computer readable instructions stored thereon associated with a diagnostic application, which when executed on the processor, has a first level of permissions for accessing the mobile device. The memory further including computer readable instructions stored thereon associated with a performance monitoring component, which when executed on the processor, has a second level of permissions for accessing the mobile device. The method including, at the diagnostic application on the mobile device, sending a monitoring request to the performance monitoring component to retrieve performance-related data associated with execution of an application on the mobile device, wherein the performance-related data is accessible using the second level of permissions. Receiving and storing by the diagnostic application performance related data from the performance monitoring component for analysing and/or optimising the performance of the mobile device executing the application. At the performance monitoring component on the mobile device, receiving the monitoring request from the diagnostic application to retrieve the performance-related data associated with the mobile device. Monitoring and storing the performance-related data accessible with second level of permissions of the mobile device during execution of the application, and sending the performance-related data to the diagnostic application for analysing and/or optimising the performance of the mobile device executing the application.

Preferably, the mobile device has a plurality of applications stored thereon and the diagnostic application further comprising selecting one or more applications of the plurality of applications to be monitored for execution on mobile device. Preferably, the diagnostic application further comprising sending a monitoring request to the performance monitoring component to retrieve performance-related data associated with execution of an application on the mobile device, where the performance-related data is inaccessible using the first level of permissions. Preferably, the diagnostic application further comprising retrieving performance-related data associated with execution of an application on the mobile device that is accessible with the first level of permissions. Preferably, instantiating the diagnostic application to execute as a background process on the mobile device. Alternatively or additionally, instantiating the performance monitoring component on the mobile device from a second mobile device coupled to the mobile device using at least a second level of permissions. Alternatively or additionally, instantiating the performance monitoring component on the mobile device during start-up of the mobile device. Preferably, the diagnostic application further comprising transmitting the performance-related data over a communications network to one or more servers for analysing the performance of the mobile device.

Preferably, the monitoring and storing of performance-related data by the performance monitoring component further comprising: activating a trace function associated with an operating system of the mobile device, the trace function for outputting trace data; scanning the trace data for trace performance data associated with the performance-related data; storing and sending the trace performance data to the diagnostic application. Preferably, sending performance-related data to the diagnostic application further comprising, for each type of performance-related data, periodically sending said each type performance-related data to the diagnostic application. Preferably, scanning the trace data further comprising periodically scanning the trace data for trace performance data.

Preferably, the performance-related data accessible with second level of permissions includes at least one from the group of: performance-related data associated with screenshots of the mobile device; performance-related data associated with frames per second of a display of the mobile device; performance-related data associated with one or more central processing unit(s) of the processor of the mobile device; performance-related data associated with power or battery consumption of the mobile device; performance-related data associated with one or more graphical processing units of the mobile device; performance-related data associated with memory or storage consumption of the mobile device; and any other performance-related data associated with the mobile device that is accessible with second level of permissions.

Preferably, the performance related data accessible with first level of permissions includes at least one from the group of: performance-related data associated with one or more central processing unit(s) of the processor of the mobile device; performance-related data associated with power or battery consumption of the mobile device; performance-related data associated with one or more graphical processing units of the mobile device; performance-related data associated with memory or storage consumption of the mobile device; and any other performance-related data associated with the mobile device that is accessible with first level of permissions.

Preferably, the mobile device has an operating system comprising components associated with Android Frameworks and a Linux Kernel, where the first level of permissions is an application level of permissions and the second level of permissions is a shell level of permissions. Preferably, the monitoring and storing of performance-related data by the performance monitoring component further comprising: activating a debugging function associated with the Android Frameworks to output debugging information associated with execution of the application on the mobile device; activating or enabling a trace function associated with the Linux Kernel component, the trace function for receiving debugging information and generating a trace pipe for outputting trace data; scanning the trace data for trace performance data associated with the performance-related data; storing the trace performance data; and sending the trace performance data to the diagnostic application.

Preferably, optimising the performance of the mobile device includes adjusting one or more operating points of hardware components of the mobile device according to a usage profile comprising one or more usage parameters for the application determined from the analysis of performance-related data associated with the application. Preferably, adjusting one or more operating points of the mobile device further comprising: collecting and maintaining the one or more usage parameters in the usage profile of the application based on the performance-related data associated with execution of the application on the mobile device; determining adjustments to one or more operating points of the mobile device based on the one or more usage parameters and the current state of the mobile device; and adjusting one or more of the operating points of the mobile device.

Preferably, determining adjustments includes at least one from the group of: determining to adjust one or more operating points of the mobile device to minimise power or battery consumption based on the usage profile; determining to adjust one or more operating points of the mobile device to maximise processing power based on the usage profile; determining to adjust one or more operating points of the mobile device to minimise processing power based on the usage profile and the application type; and determining to adjust one or more operating points of the mobile device by comparing a selected performance profile for the mobile device with the usage profile for the application.

Preferably, maintaining usage profile(s) for one or more applications on the mobile device based on performance-related data associated with the one or more applications; selecting a set of applications loading the mobile device based on one or more usage profile(s) of the one or more application(s); determining adjustments to one or more operating point(s) of the mobile device for the set of applications based on an operating profile for the mobile device; and adjusting the operating point(s) of the mobile device for each application in the set of applications when executing on the mobile device. Preferably, maintaining usage profile(s) for one or more applications further comprises maintaining usage profile(s) associated with applications in the set of applications loading the mobile device.

In an embodiment, there is provided a computer-implemented method for monitoring performance and/or optimising the performance of a mobile device, the mobile device comprising a memory and a processor, the memory including computer readable instructions stored thereon associated with a performance monitoring component, which when executed on the processor, has a second or shell level of permissions for accessing the mobile device. The method, performed on the mobile device, comprising sending a monitoring request to the performance monitoring component to retrieve performance-related data associated with execution of an application on the mobile device, where the performance-related data is accessible using the second or shell level of permissions. Receiving and storing performance related data from the performance monitoring component for analysing and/or optimising the performance of the mobile device executing the application.

In another embodiment, there is provided a computer-implemented method for monitoring the performance and/or optimising the performance of a mobile device, the mobile device comprising a memory and a processor, the memory including computer readable instructions stored thereon associated with a diagnostic application, which when executed on the processor, has a first level or an application level of permissions for accessing the mobile device. The method, performed on the mobile device, comprising: receiving a monitoring request from the diagnostic application to retrieve performance-related data associated with an application for execution the mobile device, the performance-related data being accessible using shell level of permissions; monitoring and storing the performance-related data accessible with second or shell level of permissions of the mobile device during execution of the application; and sending the performance-related data to the diagnostic application for analysing the performance and/or optimising the performance of the mobile device executing the application.

The features of each of the above aspects and/or embodiments may be combined as appropriate, as would be apparent to the skilled person, and may be combined with any of the aspects of the invention. Indeed, the order of the embodiments and the ordering and location of the preferable features is indicative only and has no bearing on the features themselves. It is intended for each of the preferable and/or optional features to be interchangeable and/or combinable with not only all of the aspect and embodiments, but also each of preferable features.

### BRIEF DESCRIPTION OF THE DRAWINGS

For better understanding of the aspects and/or embodiments described herein and to show how the same may be carried into effect, reference will now be made, by way of example only, to the accompanying figures, in which:

FIG. 1a is a schematic diagram illustrating an example mobile device according to an embodiment;

FIG. 1b is a schematic diagram illustrating the mobile device with an example system for monitoring, analysing and/or optimising the performance of the mobile device according to an embodiment;

FIG. 1c is a flow diagram illustrating an example process for a diagnostic application according to an embodiment;

FIG. 1d is a flow diagram illustrating an example process for a performance monitoring component according to an embodiment;

FIG. 2a is a schematic diagram illustrating an example system for monitoring, analysing and/or optimising the performance of an example mobile device according to an embodiment;

FIG. 2b is a schematic diagram further illustrating monitoring and retrieving performance-related data according to an embodiment;

FIG. 2c is a flow diagram illustrating an example process for a Java component according to an embodiment;

FIG. 2d is a flow diagram illustrating an example process for a native component according to an embodiment;

FIG. 2e is a flow diagram illustrating an example process for a performance monitoring component according to an embodiment;

FIG. 3a is a flow diagram illustrating an example process for a diagnostic application configured for monitoring, analysing, and/or optimising the performance of a mobile device according to an embodiment;

FIG. 3b is a flow diagram illustrating an example process for a performance monitoring component configured for monitoring and/or optimising the performance of a mobile device according to the embodiment of FIG. 3a;

FIG. 3c is a flow diagram illustrating an example process for monitoring usage profiles of applications on a mobile device according to an embodiment;

FIG. 3d is a flow diagram illustrating an example process for optimising the performance of the mobile device according to an embodiment using the monitored usage profiles of FIG. 3c;

FIG. 4a is an illustration of an example dashboard output of the performance statistics or parameter for a mobile device based on an analysis of performance-related data retrieved according to an embodiment;

FIG. 4b is an illustration of an example output of a frames-per second (FPS) performance statistics or parameter for a mobile device based on an analysis of FPS performance-related data retrieved according to an embodiment;

FIG. 4c is an illustration of an example output of a battery performance statistics or parameter for a mobile device based on an analysis of battery performance-related data retrieved according to an embodiment;

FIG. 4d is an illustration of an example output of a central processing unit (CPU) performance statistics or parameter for a mobile device based on an analysis of CPU performance-related data retrieved according to an embodiment;

FIG. 4e is an illustration of an example output of graphics processing unit (GPU) performance statistics or parameter for a mobile device based on an analysis of GPU performance-related data retrieved according to an embodiment; and

FIG. 4f is an illustration of an example output of memory performance statistics or parameter for a mobile device based on an analysis of memory performance-related data retrieved according to an embodiment.

It will also be appreciated that although features from each of the embodiments may be identified by different reference numerals in the figures and throughout the description, similar features including the properties and functionality attributed thereto, from one embodiment may be interchangeable with those of another embodiment.

### DETAILED DESCRIPTION

References will now be made in detail to the various aspects and/or embodiments, examples of which are illustrated in the accompanying figures. In the following detailed description, numerous specific details are set forth in order to provide a thorough understanding of the invention. However, it will be apparent to one of ordinary skill in the art that the invention may be practiced without these specific details.

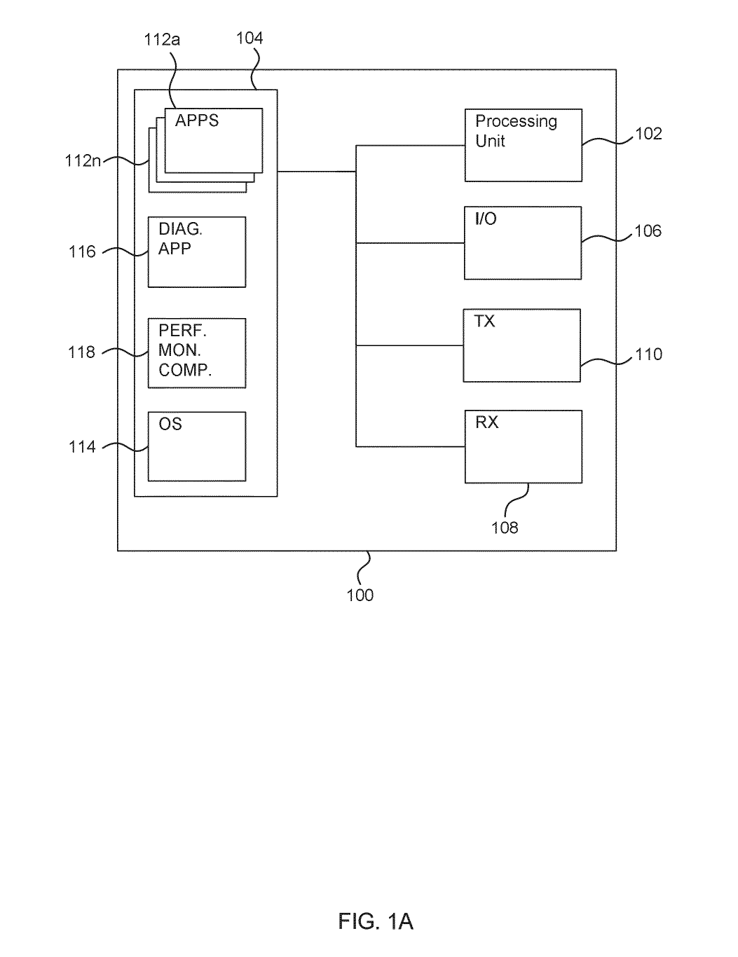

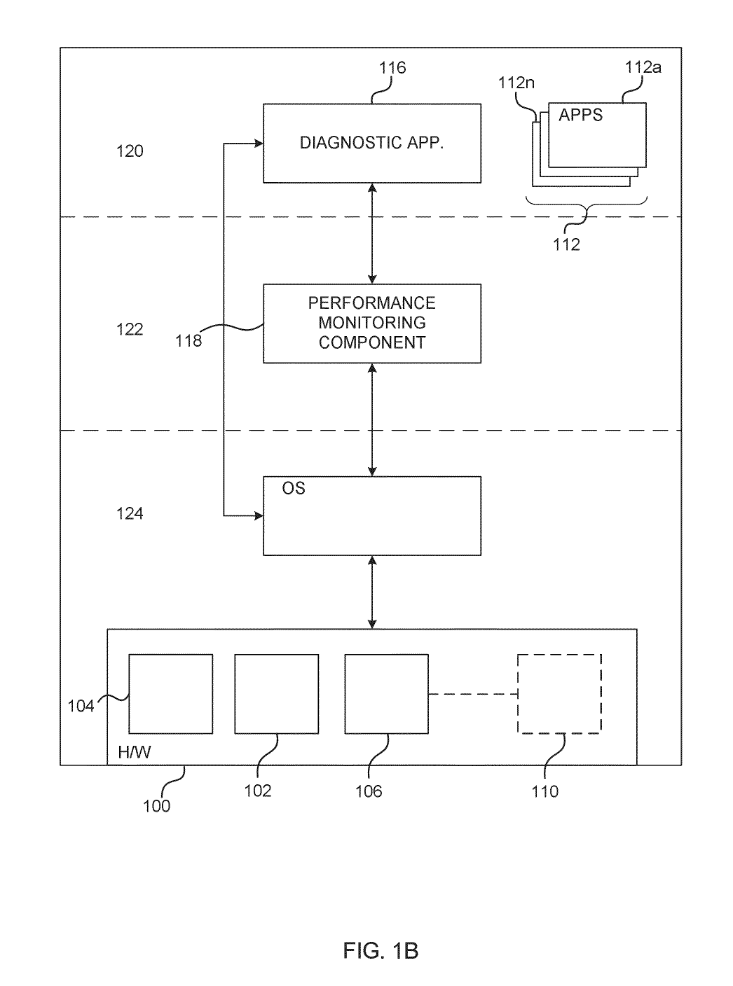

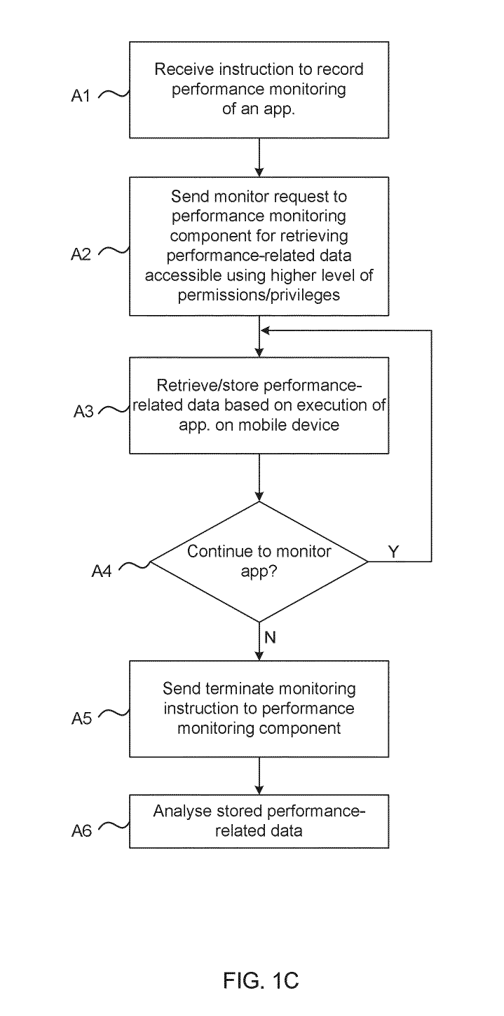

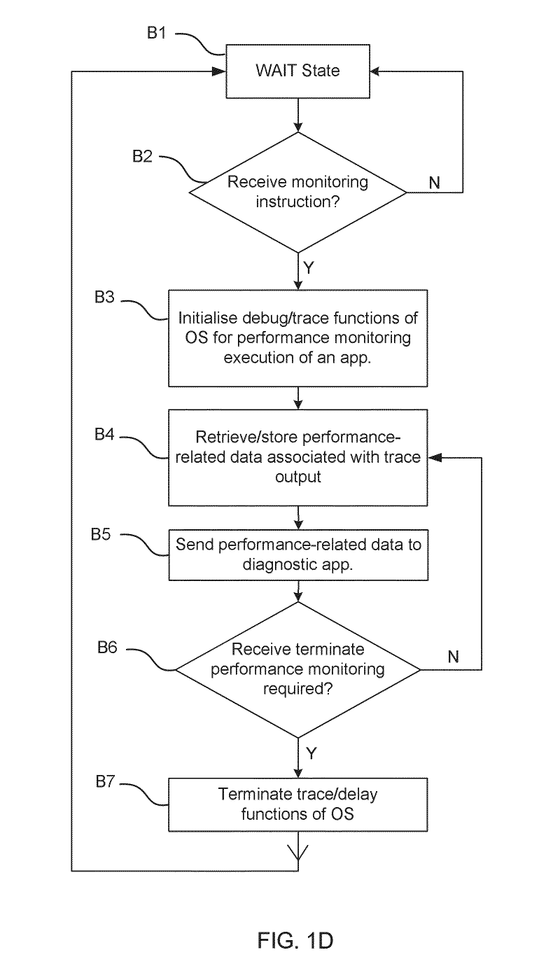

FIGS. 1a and 1b are schematic diagrams illustrating an example mobile device 100 and an example benchmarking system according to embodiments. Referring to FIG. 1a, the mobile device 100 includes a processing unit 102, a storage unit 104, an input/output unit 106, a receiver 108 and a transmitter 110, in which the processing unit 102 is coupled to the storage unit 104, the I/O unit 106, the receiver 108 and transmitter 110. The storage unit 104 may comprise one or more for computer readable mediums (e.g. solid-state or flash memory, random access memory, read only memory, hard-disk drive, optical disc) for use in storing program instructions associated with a plurality of applications 112 (e.g. applications 112a-112n that may include games, social networking applications, spreadsheets, utility applications, word processing, email, web browsers, calendars, address books, and any other user application program configured for execution on processor 102, etc.), an operating system 114 (OS) (e.g. OSs such as Android®, Linux®, Windows®, Apple iOS®, etc.), a diagnostic application 116 and a performance monitoring component 118 for use in performing one or more functions associated with benchmarking, performance monitoring, system monitoring, security monitoring, performance analysis and system optimisation of one or more applications executing on the mobile device 100.

Referring to FIG. 1b, permissions/privileges are used by the OS 114 to control a particular application's or component access to system functions. Typically there are several levels of permissions/privileges given to applications 112, certain background processes or components, and the OS 114. For example, the plurality of applications 112 and diagnostic application 116, which when executed on the processor 102, are configured to have a first level of permissions/privileges 120 (e.g. an application level of permissions/privileges) for accessing the OS 114, where the first level of permissions/privileges 120 allow the applications 112 or 116 to access via the OS 114 certain hardware/systems of the mobile device 100 (e.g. processing unit 102 including one or more central processing units and/or graphics processing units, storage unit(s) 104 such as volatile storage such as RAM, or persistent storage such as ROM, flash, hard-disk or solid state and other types of storage or memory, I/O 106 such as keyboard, touch screen and associated displays, receiver/transmitters 108/110 and other hardware).

The performance monitoring component 118, which when executed on the processor 102, is configured to have a second level of permissions/privileges 122 (e.g. a higher level of permissions/privileges) than the first level of permissions/privileges 120 (e.g. a higher application level of permissions/privileges and/or a shell level of permissions/privileges) for accessing the OS 114 of the mobile device 100. The second level of permissions/privileges 122 also includes the first level of permissions/privileges 120, while allowing the component 118 even more access via the OS 114 to the underlying hardware/system of the mobile device 100 that would otherwise be restricted for applications 112 and 116 with the first level of permissions/privileges. The second level of permissions/privileges 122 provides a component (e.g. performance monitoring component 118) access to the hardware or information associated with the hardware of the mobile device 100 that would otherwise be inaccessible when using the first level of permissions/privileges 120 (e.g. an application level of permissions/privileges 120 associated with applications 112 and 116).

The OS 114, which when executed on the processing unit 102 of the mobile device, generally has a full level of permissions/privileges 124 (e.g. a system level of permissions/privileges or an administrator level of permissions/privileges) that provides the OS 114 with access to all of the underlying hardware of the mobile device 100 and allows the OS 114 to control and share access to the hardware and/or information associated with the hardware of the mobile device to applications 112/116 and other components 118 when executing on the mobile device 100. The full level of permissions/privileges 124 includes at least both the first level of permissions/privileges 120 (e.g. an application level of permissions/privileges) and the second level of permissions/privileges 122 (e.g. a higher level of permissions/privileges or a shell level of permissions/privileges), and further permissions/privileges as required for operating the hardware/systems of the mobile device 100.

For example, for a mobile device 100 with an OS 114 such as Apple iOS, Windows 8 or any other similar type of OS 114, the plurality of applications 112 and the diagnostic application 116, which when executed on the processor, may each be given a certain application level of permissions/privileges within the first level of permissions/privileges 120 depending on the required functionality of the applications 112 and 116. For example, each of the applications 112 or 116 may have at least a subset of the first level of permissions/privileges depending on the hardware/software of the mobile device 100 that the application may need to have access to or communicate with when it is executed on the mobile device 100. For example, the application level privileges/permissions 120 for accessing the OS 114 may be provided to each of these applications 112 and 116 on installation and/or with user agreement.

As well, the performance monitoring component 118, which when executed on the processor, may be provided with a higher application level of permissions/privileges provided within the second level of permissions/privileges 122 but not within the first level of permissions/privileges 120 for accessing the OS 114 and underlying hardware of the mobile device 100. For example, the performance monitoring component 118 may have at least a subset of the second level of permissions/privileges (e.g. a higher application level of privileges/permissions) depending on the hardware/software of the mobile device 100 that the performance monitoring component 118 may need to have access to or communicate with when it is executed on the mobile device 100. The second level of permissions/privileges 122 may also include the first level of permissions/privileges 120 (e.g. an application level of permissions/privileges). The second level of permissions/privileges allows the performance monitoring component 118 to have even more access to the OS 114 and the underlying hardware/system of the mobile device 100. The second or higher level of permissions/privileges 122 provides a component (e.g. performance monitoring component 118) access to the hardware or information associated with the hardware of the mobile device 100 that would otherwise be inaccessible when using the first level of permissions/privileges 120 (e.g. application level of permissions/privileges).

In another example, for a mobile device 100 with an OS 114 such as Android or other Linux based OS 114, there are several different levels of privileges/permissions. Typically, the plurality of applications 112 and the diagnostic application 116, which when executed on the processor, will be given a first level of permissions/privileges 120 referred to as an application level of permissions/privileges 120 depending on the required functionality of the applications 112 and 116. For example, each of the applications 112 or 116 may have at least a subset of the first level of permissions/privileges depending on the hardware/software of the mobile device 100 that the application may need to have access to or communicate with when it is executed on the mobile device 100. The applications 112 and 116 execute in a “sandboxed” environment and are not allowed to have a second level of permissions/privileges (e.g. a shell level of permissions/privileges). The performance monitoring component 118, which when executed on the processor, is provided with a second level of permissions/privileges 122, which is referred to as a shell level of permissions/privileges 122 that provides the component 118 access to the OS 114 and hardware of the mobile device 100 would otherwise be inaccessible to any applications 112 or 116 that only have the first level of permission/privileges or an application level of privileges/permissions.

In both scenarios, the OS 114 typically has a full level of permissions/privileges 124 (e.g. system or administrator level of permissions/privileges) allowing it to access and operate the hardware of the mobile device 100 and grant permission to applications 112 and 116 and components 118 for accessing the underlying hardware depending on the corresponding level of permissions/privileges given to the applications 112 and 116 and components 118.

Initially, the processing unit 102 executes the program instructions associated with the OS 114 (e.g. iOS, Windows 8, Android or other OS etc.), which controls access to the hardware of the mobile device 100 for the plurality of applications 112, the diagnostic application 116 and performance monitoring component 118. The processing unit 102 may then execute, under the control of the OS 114, program instructions stored in the storage unit 104 associated with one or more applications of the plurality of applications 112 for performing various processing and I/O tasks associated with the one or more applications 112 in accordance with the application level of permissions/privileges 120. A user of the mobile device 100 may use the diagnostic application 116 to profile or benchmark the execution of one or more of the applications 112 on the mobile device 100. This provides developers and users with a real world understanding of the hardware/software performance that each of the different applications 112 or combinations of applications 112 may have when executing on the mobile device 100. This also allows a comparison of a set of mobile devices based on actual real-world applications and content instead of relying on preconfigured benchmarking applications.

In operation, when the diagnostic application 116 is launched it is executed by the processor 102 in accordance with a first level of permissions/privileges 120 i.e. the application level of permissions/privileges 120. The performance monitoring component 118 is also executed by the processor 102 in accordance with a second level of permissions/privileges 122 i.e. a higher level of permissions/privileges 122 than the application level of permissions/privileges 120 (e.g. a higher level of application privileges/permissions for an Apple iOS or Windows 8 OS or a shell level of privileges/permissions for an Android OS). The performance monitoring component 118 may be executed in the background on the mobile device 100, and may persist even when the user does not wish to perform benchmarking or related monitoring using the diagnostic application.

The performance monitoring component 118 may be launched with the second level of permissions/privileges 122 (e.g. higher application/shell permissions/privileges) by the OS 114 on start-up of the mobile device 100 as a background process. Alternatively, if allowed, the user may launch the performance monitoring component 118 with the second level of permissions/privileges 122. However, typically this is not allowed by most mobile devices 100 as most applications 112 and components accessible by the user can only be executed in a “sandboxed” execution environment in which the applications 112 and components are only allowed to have a first level of permissions/privileges 120. This is a security measure to maintain the security and integrity of the core components and data stored on the mobile device 100. Alternatively or additionally, the performance monitoring component 118 may also be launched on the mobile device 100 by the user when the mobile device 100 is coupled to a second computing device that is capable of launching components or applications on the mobile device 100 that use the second level of permissions/privileges (e.g. higher application level or shell level of permissions/privileges).

Once the performance monitoring component 118 has been launched it “sleeps” in a wait state. The performance monitoring component 118 begins in a wait state and only enters a monitoring state when instructed by the diagnostic application 116. In essence, since some or all of the performance-related data required by the diagnostic component 116 may be accessible using a second level of permissions (e.g. higher application level or a shell level of permissions), the diagnostic component 116 is configured to instruct performance monitoring component 118 to enter a monitoring state for initiating retrieval of performance-related data associated with execution of the application on mobile device 100.

Performance-related data may comprise or represent any data representative of the performance of one or more hardware and/or software components or elements of a mobile device 100. Examples of performance-related data that may be used in certain embodiments of the described mobile devices, apparatus, methods and systems may be data representative of, but not limited to, screenshots of the mobile device 100, frames per second (e.g. FPS) of graphics displayed on the mobile device 100, performance data associated with one or more central processing unit(s) (CPU(s)) of the processing unit 102 of the mobile device 100, power or battery consumption of the mobile device 100, performance data associated with one or more graphical processing unit(s) (GPU(s)) of processing unit 102 of the mobile device 100, data associated with memory or storage consumption or usage storage unit 104 of the mobile device 100, any other performance-related data associated with the hardware and/or software of the mobile device 100. Further examples of performance-related data are provided herein.

The performance-related data accessible by applications or components having the second level of permissions/privileges 122 (e.g. higher application level or shell level of permissions/privileges) may include at least one or more of data from the group of:
screenshots of the mobile device 100;
frames per second (e.g. FPS) of a display of the mobile device 100;
performance data associated with one or more central processing unit(s) (CPU(s)) of the processing unit 102 of the mobile device 100;
power or battery consumption of the mobile device 100;
performance data associated with one or more graphical processing unit(s) (GPU(s)) of processing unit 102 of the mobile device 100;
memory or storage consumption or usage storage unit 104 of the mobile device 100;
any other performance-related data associated with the mobile device 100 that is accessible with the second level of permissions/privileges 122;
any other performance-related data that may, in the future, be accessible by components with the second level of permissions/privileges 122.

Each portion of the performance-related data (e.g. performance of CPU, GPU, frames-per-second, screen-shots, memory usage, battery consumption), may be periodically retrieved by the performance monitoring component 118 or the diagnostic component 116. However, since each type of performance-related data will change at different rates, the retrieval of each portion of the performance-related data may occur at different frequencies/periods of time. For example, CPU performance may be retrieved once per second, battery consumption data may be retrieved every 30 seconds, frames-per-second may be retrieved 1/60^{th} of a second (e.g. 60 Hz), memory usage performance once per second. These periods for retrieving the performance-related data are given by way of example only and it is to be appreciated by the person skilled in the art that each mobile device 100 may require or use different periodic retrieval times for each type or portion of the performance-related data.

For example, should the performance monitoring component 118 be configured to retrieve all the performance-related data for the diagnostic application 116, the performance monitoring component 118 may instantiate retrieval process threads for retrieval of each different type of performance-related data. For example, to retrieve performance-related data such as data representative of: 1) CPU; 2) battery/power consumption; 3) GPU; 4) memory consumption/usage; 5) frame-per-second data; and 6) screen shot data; then 6 different retrieval process threads may be instantiated. Each retrieval process thread that is instantiated may monitor/retrieve its performance-related data periodically or when the performance-related data is available and subsequently provide it, e.g. via the performance monitoring component 118, to the diagnostic application 116 for storage, analysis for determining performance statistics/parameters associated with the performance-related data, and/or optimisation of the mobile device based on the performance statistics etc.

In the monitoring state, the performance monitoring component 118 sends performance-related data to the diagnostic component 116 during execution of the application and returns to the wait state on instruction from the diagnostic application 116 to terminate monitoring. The performance-related data collected by the performance monitoring component 118 and sent to the diagnostic application 116 and/or collected directly by the diagnostic application 116 is used in performing one or more functions associated with benchmarking, performance monitoring, system monitoring, security monitoring, performance analysis and/or system optimisation of one or more applications executing on the mobile device 100.

In particular, since some or all of the performance-related data required by the diagnostic component 116 may be accessible using a second level of permissions 120 (e.g. higher application level or a shell level of permissions/privileges), the diagnostic component 116 is configured to send a monitoring request or instruct the performance monitoring component 116 to retrieve performance-related data associated with execution of an application 112a on the mobile device 100. The performance monitoring component 118, once launched, starts off in the wait state that monitors a communication socket for use in local communication with the diagnostic application 116 or waits in the background for a request from the diagnostic application 116 to begin monitoring of performance-related data associated with execution of an application on the mobile device 100.

For example, on receiving the monitoring request or detecting the request, the performance monitoring component 118 changes to a monitoring state and instructs the OS 114 (e.g. in an Android or Linux type environment) to implement debugging or trace functionality, filtering any debugging/trace output for performance-related data associated with execution of the application 112a that the diagnostic application 116 requires, and sends the filtered performance related data to the diagnostic application 116 for use in recording the performance of the execution of the application.

In another example, the monitoring and storing of performance-related data by the performance monitoring component 118 may include activating a trace function associated with the OS 114 of the mobile device. The trace function may output trace data to a trace pipe or trace queue (e.g. a first-in first-out queue). The performance monitoring component 118 may be configured to scan the trace data and detect trace performance data associated with the performance-related data. That is the trace output data is filtered by the performance monitoring component 118 to retrieve any trace data that corresponds to the performance-related data that is required by the diagnostic component 116. For each of the corresponding portions of performance-related data the diagnostic component 116 may require from the performance monitoring component 118, the performance monitoring component 118 stores and/or sends this data to the diagnostic component 116. The trace output data may provide a fine granularity or a low-level of performance-related data that may be accessible. For example, the trace output data may include CPU data that can provide more insight into CPU performance when trace is enabled. For instance, in a multi-core system, or a system with multiple CPU cores, the trace output data of the trace pipe can provide information associated with the threads that are executing in each CPU core. The trace pipe may be useful for retrieving in-depth performance-related data.

Once the performance monitoring of the application is complete, e.g. the diagnostic application 116 may instruct the performance monitoring component 118 to terminate monitoring, in which the performance monitoring component 118 instructs the OS 114 to terminate debugging/trace functionality and enters the wait state again.

Given that the performance monitoring component 118 has second level of permissions/privileges 122 or more access to the underlying hardware of the mobile device 100 than the diagnostic application 116, in some embodiments, it may be configured to retrieve all or most of the performance-related data for sending to the diagnostic application 116. However, this may put some strain on the performance monitoring component 118 in delivering all or most of the performance-related data to the diagnostic application 116.

Instead, some performance-related data such as general CPU data, memory data and battery data may be measured or retrieved using applications 112 or 116 with a first level of privileges/permissions (e.g. an application level of permissions/privileges). The diagnostic application 116 may be configured to relieve the performance monitoring component 118 in some of its duties in collection/retrieval of performance-related data during execution of the application. That is, the diagnostic application 116 may also be configured to directly retrieve performance-related data that is accessible from the OS 114 by applications 112 and the diagnostic application 116 with only first level of permissions/privileges 120. Such performance-related data that is accessible with the first level of permissions/privileges 120 may include at least one or more data from the group of:
performance-related data associated with one or more CPU(s) of the processing unit 102 of the mobile device 100;
performance-related data associated with one or more GPU(s) of the processing unit 102 of the mobile device 100;
performance-related data associated with memory or storage consumption or usage of storage unit 102 of the mobile device 100;
performance-related data associated with battery or power consumption or usage of battery or power source of the mobile device 100;
any other performance-related data associated with the mobile device 100 that is accessible with a first level of permissions/privileges 120; and
any other performance-related data that may, in the future, be accessible by components with a first level of permissions/privileges 120.

The performance-related data of one or more CPU(s) of the processing unit 102 of the mobile device 100 may be measured and analysed to determine CPU performance statistics/parameters such as the percentage of time spent by the application 112a (e.g. the profiled application) between two sampling data points related to the CPU. For example, in a mobile device 100, using the Android OS 114 with a Linux Kernel by way of example only, the diagnostic application 116 may be configured to use the /proc/filesystem in Linux to get CPU usage statistics of a process (e.g. the application 112a). A file called /proc/stat typically includes several entries about overall CPU usage. A file called /proc/{pid}/stat with the {pid} being the process identity (or id) assigned by Linux to an application such as the application 112a, will contain statistics about the application 112a (or profiled application/process). These two files may provide information about the CPU Usage of the application 112a. These two files are read periodically to get a trend of CPU Usage for the application 112a.

Performance-related data such as CPU Frequency may also be measured for individual cores while the application 112a is profiled/executed on the mobile device 100. For example, in a mobile device 100, using the Android OS 114 with a Linux Kernel by way of example only, Linux has a /sys/filesystem that the diagnostic application 116 may profile/read for various CPU parameters like CPU on/off, CPU Scaling frequencies, operating frequencies etc., where, for instance, the file /sys/devices/system/cpu/cpu0/online may provide the online state of the CPU core0.

Performance-related data for the GPU may be collected based on the type of access to the GPU that each manufacturer allows. For example, in a mobile device 100, using the Android OS 114 with a Linux Kernel by way of example only, for QUALCOMM GPUs (e.g. Adreno), the diagnostic application 116 may profile/read a /sys/file (e.g. /sys/class/kgsl/kgsl-3d0/gpubusy), that includes GPU performance-related data for inferring GPU Utilisation. For Nvidia GPUs, the GPU utilization may be measured by the diagnostic application 116 also using a /sys/file. In another example, for Imagination GPUs, a Software Development Kit (SDK) called PVRScope may be provided, in which the performance monitoring component 118 may be configured to use PVRScope to turn on certain hardware counters that provide GPU Usage information. The performance monitoring component 118 reads/filters the performance-related data for the GPU and sends this to the diagnostic application 116.

Performance-related data associated with memory or storage consumption or usage of storage unit 102 of the mobile device 100 may be based on reports on memory usage of all running applications/processes on the mobile device 100. For example, in a mobile device 100, using the Android OS 114 with a Linux Kernel by way of example only, an Application Programming Interface (API) provided by Android can be used by the diagnostic application 116 for receiving reports on memory usage of all the running processes/applications on mobile device 100. This API may be called periodically to analyse and determine the total RAM usage of the application 112a that is executed/profiled on the mobile device 100.

Performance-related data associated with the battery or power consumption or usage of battery or power source of the mobile device 100 may also be retrieved by the diagnostic application 116. For example, in a mobile device 100, using the Android OS 114 with a Linux Kernel by way of example only, an Android API may be used by the diagnostic application 116 to measure the Battery once every n seconds (e.g. 30 seconds). Alternatively or additionally, the performance monitoring component 118 may use its shell level of privileges/permissions to measure more detailed statistics for the battery such as, by way of example only, current/voltage etc.

In any event, the performance-related data measured and collected by the performance monitoring component 118 and/or the diagnostic application 116 is stored and/or analysed by the diagnostic application 116. Alternatively or additionally, the diagnostic application 116 may forward the collected performance-related data to one or more servers (e.g. a cloud data analytics service) or a second computing system for further analysis, the results of which may be provided to the diagnostic application 116 for display to the user of the mobile device 100.

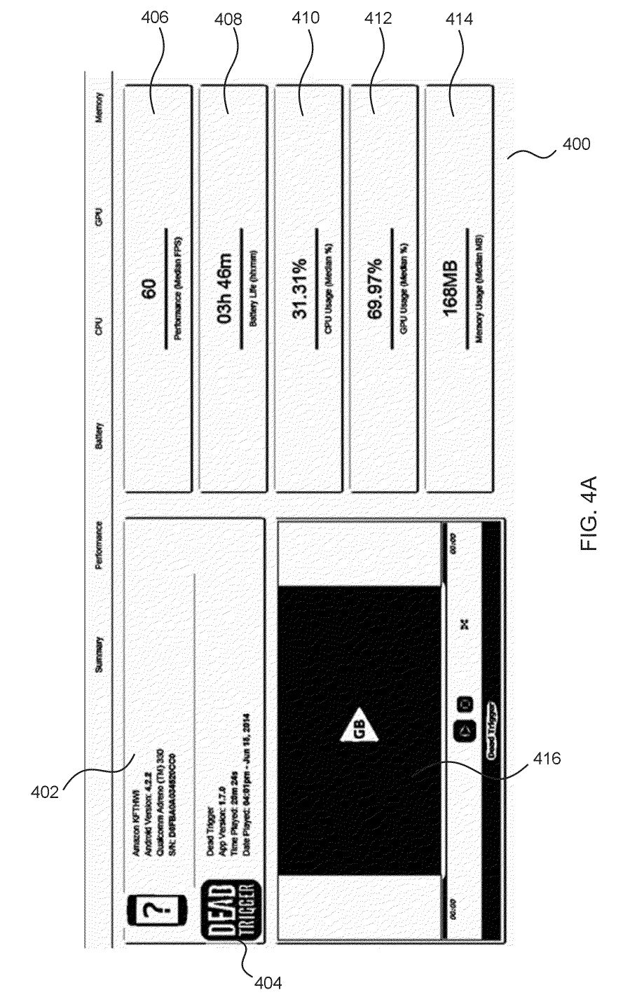

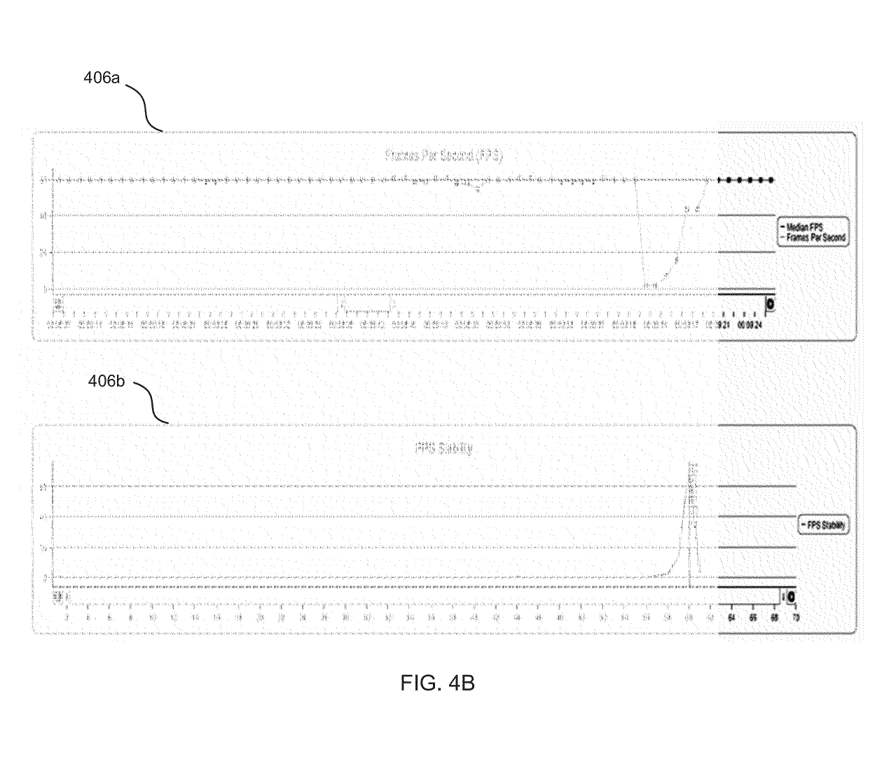

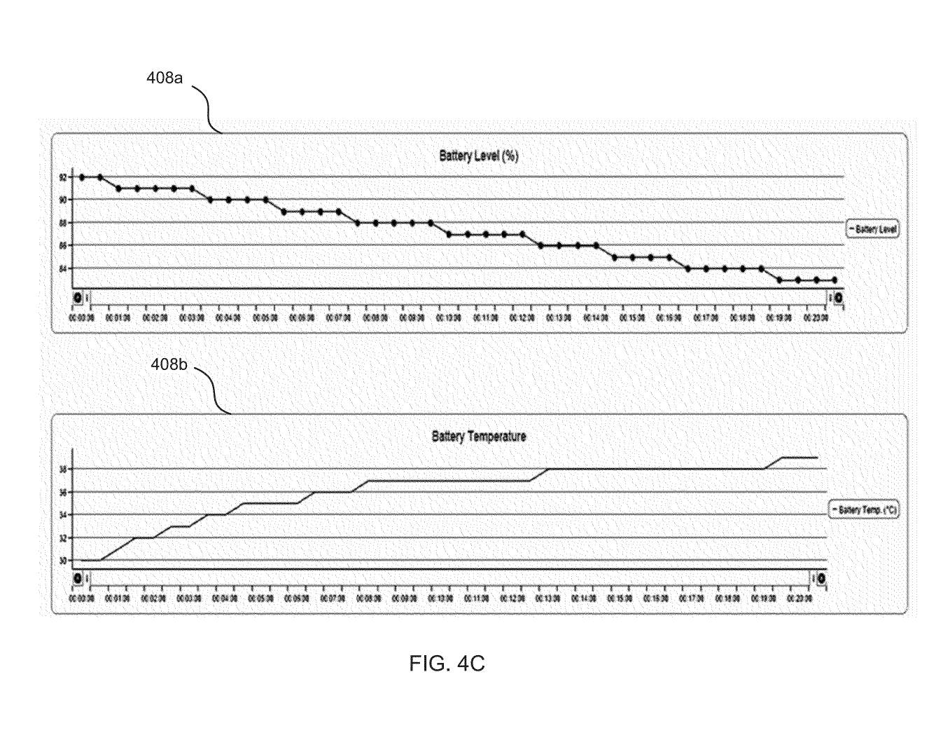

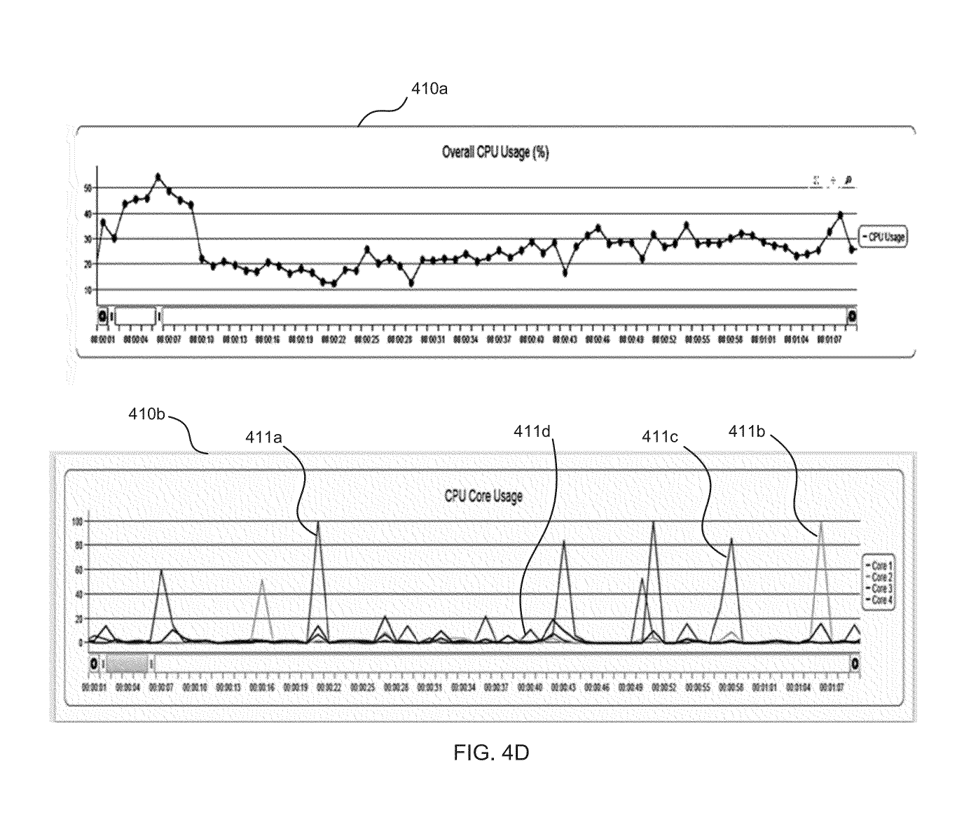

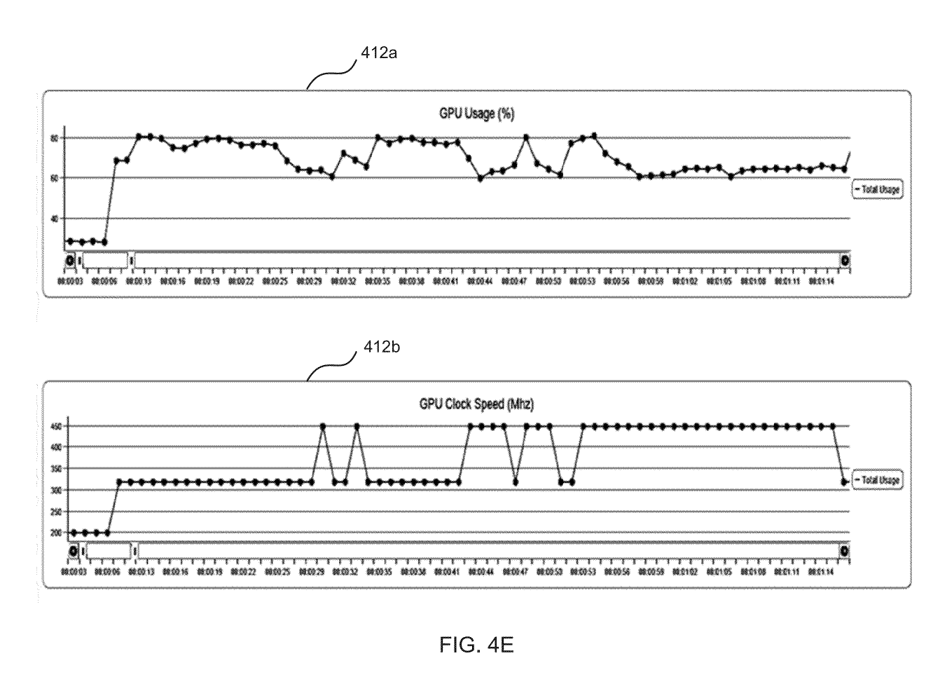

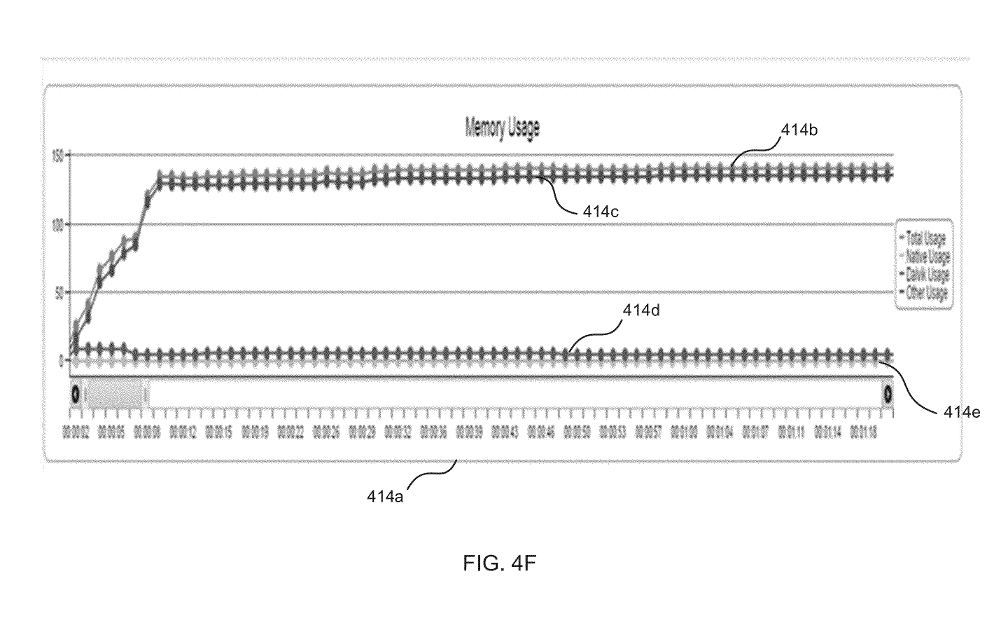

For example, FIG. 4a illustrates an example dashboard 400 output of performance statistics or parameters for a mobile device 100 (e.g. an Amazon®KFTGWI handset 402) when executing an application (e.g. a game application 404 called Dead Trigger®) based on an analysis of performance-related data retrieved. The game application 404 executed on the mobile device 100 for 20 minutes and 24 seconds during which performance-related data was collected by the diagnostic application 116 and/or performance monitoring component 118. The performance-related data may be analysed to provide an FPS performance statistic(s) or parameter(s) 406 (e.g. median FPS of 60 fps), a battery performance statistic(s) or parameter(s) 408 (e.g. Battery life (hh:mm) of 03 hours and 46 minutes), a CPU performance statistic(s) or parameter(s) 410 (e.g. CPU usage of the application such as median CPU usage of the application as a percentage, in this case, 31.31%), GPU performance statistic(s) or parameter(s) 412 (e.g. GPU usage of the application such as median GPU usage as a percentage, in this case, 69.97%), and memory performance statistic(s) or parameter(s) 414 (e.g. memory usage such as median memory usage in megabytes (MB), in this case, 168 MB). In this example, the dashboard 400 also includes a screenshot player 416 that may play the performance-related data associated with screenshots gathered by the performance monitoring component 118 during execution of the application 404 on the mobile device 100. One or more of these performance statistic(s)/parameter(s) or performance-related data 406-416 may be displayed to the user on the dashboard 400 on the mobile device 100 via the diagnostic application 116, or to the user on a dashboard 400 via a web browser from a performance analysis server or website (e.g. a cloud analytics service) during or after receiving the performance-related data collected by the diagnostic application 114 and/or performance monitoring component 118, and/or via a host PC or computing device coupled to the mobile device 100 during or after receiving the performance-related data collected by the diagnostic application 114 and/or performance monitoring component 118.

Although six performance statistics are illustrated in FIG. 4a, the dashboard output may presented to the user, it is to be appreciated by the skilled person that one or more statistics or a summary of the statistics based on an analysis of the performance-related data may be presented to the user. This may depend on the screen size of the display of the device from which the user may be viewing the statistics, or on the number of performance-related statistics or parameters that may be selected to be output from the analysis of performance-related data retrieved from the mobile device. The terms statistics or parameters may be used interchangeably.

Referring back to FIGS. 1a-1b, should the diagnostic application 116 retrieve performance-related data that is accessible with first level of permissions/privileges 120, the diagnostic application 116 may be configured to implement threaded execution for retrieval of each type of performance-related data that is accessible to it. This means that multiple threads may exist during retrieval of the performance-related data, each thread related to retrieval of a different type or portion of the performance-related data. The threads instantiated by the diagnostic application 116 will only have a first level of privileges/permissions when accessing the underlying hardware/software (e.g. Android Frameworks/Linux Kernel) of the mobile device 100. For example, the diagnostic application 116 may also instantiate four retrieval process threads for retrieval of four different types of performance-related data such as data representative of: 1) CPU; 2) battery/power consumption/usage/life; 3) GPU; and 4) memory consumption/usage, which may be accessible using first level of permissions/privileges 120. This means that the performance monitoring component 118 may only need to instantiate one or more retrieval process threads, which will have a second level of permissions/privileges for accessing the underlying hardware/software of the mobile device 100, for retrieval of other types of performance-related data such as data representative of: 1) frame-per-second data; and 2) screen shot data that may be inaccessible to the retrieval process threads having a first level of permissions/privileges. Thus, the diagnostic application 116 may relieve the performance monitoring component 118 of some of the burden in retrieving the performance-related data. Each retrieval process thread that is instantiated by either the diagnostic application 116 and/or performance monitoring component 118 may monitor/retrieve its performance-related data periodically or when the performance-related data is available and provide it to the diagnostic application 116 for storage/analysis etc.

The diagnostic application 116 may store the retrieved performance-related data may for use in performing one or more functions associated with benchmarking, performance monitoring, system monitoring, security monitoring, performance analysis, and system optimisation of one or more applications executing on the mobile device 100. In relation to benchmarking, the retrieved performance-related data may be analysed by the mobile device 100 and the performance of the application 112a executing on the mobile device 100 may be displayed/stored for subsequent display or presentation to the user of the mobile device 100.

Alternatively, the retrieved performance-related data may be forwarded over a communication network to a server for analysis or a more detailed analysis (e.g. cloud based storage solution or a cloud based performance analysis system) of the application 112a, which may then present the performance analysis to the user via the diagnostic application 116, a web browser or any other application. Alternatively or additionally, the performance-related data may be sent to a computing device with a larger display than the mobile device 100 (e.g. sent over a communication network or via a wired connection to the computing device) for analysis or a more detailed analysis of the application 112a executing on the mobile device 100, which may then present the performance analysis to the user on the larger screen of the second computing device.

For example, performance statistics such as the total CPU usage performance for an application 116 may be analysed from the performance-related data associated with the CPU (e.g. CPU performance-related data) by determining the percentage CPU usage of the application 112a within a time interval e.g. between two time intervals t1 and t2. As an example, if the calculated CPU Usage for the application 112a is 20%, then the application 112a consumed 20% of CPU time between t1 and t2. If the CPU usage was measured every second, this means that the application 112a spent 200 ms on the CPUs. The more the time spent by the application 112a using the CPU, the higher the CPU utilisation/usage.

The diagnostic application 116 may be further configured to monitor a set of the applications 112 or a selection of one or more applications 112a-112e for execution on the mobile device. As each application 112a-112e is to be monitored for execution on mobile device, the diagnostic application 116 and performance monitoring component 118 may be configured to retrieve performance-related data for each of the set or selection of applications 112a-112e in a similar fashion as already described when the applications 112a-112e execute on the mobile device 100. The performance-related data for each of the applications 112a-112e is collected by the diagnostic application 116 and analysed, stored for subsequent analysis, and/or sent for further analysis.

For example, the performance-related data that is retrieved by the diagnostic application 116 may be analysed to output performance statistics/parameters. As an example, the performance statistics/parameters may be used to display (e.g. via the I/O 106) performance of the mobile device 100 and/or the one or more applications 112a or 112 executing on the mobile device 100 to the user. The performance analysis may be performed by the diagnostic application 116 and/or performance monitoring component 118 or other suitable application or component on the mobile device 100. Alternatively, the retrieved performance-related data may be sent using receiver 108/transmitter 110 to a server or host computing system configured to perform the performance analysis on the retrieved performance-related data and provide performance statistics/parameters to the mobile device 100 (e.g. to the diagnostic application 216 and/or performance monitoring component 118, or any other suitable application). Alternatively or additionally, the performance statistics/parameters may be used to adjust/optimise the performance of the mobile device 100 during execution of the one or more applications 112a or 112. The diagnostic application 116 and/or performance monitoring component 118 or other suitable application or component on the mobile device 100 may be configured to perform the adjustments/optimisation of the mobile device 100.

For example, the diagnostic application 116 may further include a system optimisation component that uses, for each application 112a-112n, the retrieved performance-related data or an analysis of the retrieved performance-related data to adjust one or more operating points of hardware components (e.g. increasing/decreasing CPU clock speeds of the processor 102, increasing/decreasing power/battery consumption, increasing/decreasing memory usage or consumption of storage unit 104, etc.) of the mobile device 100 to efficiently or optimally execute each application 112a-112n according to a usage profile for each application(s) 112a-112n. The usage profile for an application 112a may include usage parameters such as usage time of the application 112a executing on the mobile device 100 and/or performance statistics for the application 112a that are determined from a performance analysis of retrieved performance-related data associated with the application 112a.

Performance-related data associated with, by way of example only but not limited to, CPU, battery/power consumption, GPU, memory consumption/usage, frames-per-second data, and screen shot data may be analysed to get the a set of statistical performance-parameters such as average, maximum, minimum, and/or median CPU clock speeds, battery/power consumption, GPU performance, memory consumption/usage, and frame rate data parameters, and any other suitable performance parameters/statistics of the mobile device that may result from an analysis of the performance-related data. This data may be compared with a previous usage profile of the application 112a and/or optimal or desired usage profile for the application 112a and/or a set of performance profiles for the mobile device 100.

For example, an optimal usage profile for the application 112a may be a set of parameters/statistics based on the application developer's minimum/maximum hardware configuration or settings of the mobile device 100 for providing the best user experience when the application 112a executes on the mobile device 100. As another example, the desired usage profile for the application 112a may be a set of parameters/statistics based on the user's desired or chosen hardware configuration and/or settings of the mobile device 100 when executing the application 112a on the mobile device 100. As a further example, the mobile device 100 may also have a set of performance profiles each associated with a set of parameters/statistics corresponding to various hardware configurations or settings. Examples of performance profiles of the mobile device 100 may be: a) a maximum performance profile that optimises the hardware settings of the mobile device 100 for maximum possible execution performance of the application 112a; b) maximum possible display rate for the application 112a; and/or c) a minimum power/battery consumption or economy performance profile. Such performance profiles may also be user defined.

In particular, the system optimisation component of the diagnostic application 116 may include collecting and maintaining the usage parameters/statistics including one or more performance parameters/statistics in the usage profile of the application 112a based on the performance-related data associated with execution of the application 112a on the mobile device. During performance monitoring of the application, the system optimisation component may determine adjustments to the one or more operating points of the hardware components and/or software (e.g. OS 114) of the mobile device 100 based on updated analysis/calculation of the usage parameters/statistics, the type of application 112a and/or the current operating state of the mobile device 100.

For example, determining the adjustments includes at least one from the group of:
determining to adjust one or more operating points of the hardware components and/or software of the mobile device 100 to minimise power or battery consumption based on the usage profile;
determining to adjust one or more operating points of the hardware components and/or software of the mobile device 100 to maximise processing power based on the usage profile;
determining to adjust one or more operating points of the hardware components and/or software of the mobile device 100 to minimise processing power based on the usage profile and the application type;
determining to adjust one or more operating points of the hardware components and/or software of the mobile device 100 by comparing the usage profile with a desired or optimal usage profile for the application; and
determining to adjust one or more operating points of the hardware components and/or software of the mobile device by comparing a selected performance profile for the mobile device 100 with the usage profile for the application.

Once determined, the system component may adjust one or more of the operating points of the hardware components and/or software of the mobile device. If the operating points can be adjusted by applications/components with a first level of permissions/privileges 120, then the diagnostic application 116 may be used to instruct the OS 114 to adjust the required operating points of the mobile device 100. Alternatively or additionally, for those operating points that cannot be adjusted from an application/component using a first level of permissions/privileges 120, then another component with a higher level of privileges (e.g. a second level of privileges) such as having at least a subset of the second level of permissions/privileges 122 may be used. For example, the performance monitoring component 118 with at least a subset of the second level of permissions/privileges may include a system adjustment/optimisation component or functionality for receiving instructions/requests to adjust the operating points of the hardware components and/or software of the mobile device 100. The requests/instructions may include data representative of the operating point and/or the adjustment required in relation to the operating point. The performance monitoring component 118 via the system adjustment/optimisation component may instruct the OS 114 to adjust the requested operating point(s) of the mobile device 100. Thus a performance feedback loop may be created based on monitoring and retrieving performance-related data associated with one or more applications 112 and adjusting the operating point of the mobile device 100 based on performance parameters/statistics from an analysis of the retrieved performance-related data to adaptively optimise the performance of the mobile device 100 and/or the one or more applications 112 executing on the mobile device 100.

FIG. 1c is a flow diagram illustrating an example process for a diagnostic application 116 according to an embodiment, for example, the diagnostic application 116 as described in relation to FIGS. 1a and 1b. The mobile device 100 may include a storage unit 104 such as a memory or computer readable medium that includes computer readable instructions associated with one or more applications 112a, 112 an operating system 114, the diagnostic application 116 and a performance monitoring component 118. The diagnostic application 116, which when executed on the processing unit 102 of the mobile device 100 has a first level of permissions/privileges and the performance monitoring component 118, which when executed on the processing unit 102, has a second level of permissions/privileges (e.g. higher level of permissions/privileges than the first level of permissions/privileges), where the second level of permissions/privileges provide further permissions/privileges for accessing hardware of the mobile device 100 than the first level of permissions/privileges. The diagnostic application 116 performs, by way of example, a process for monitoring and/or analysing (e.g. benchmarking) the performance of an application 112a for execution on the mobile device 100 based on the following:
A1. Receive an instruction to record performance monitoring of an application 112a. Proceed to A2.
A2. Sending a monitoring request to the performance monitoring component 118 to begin the monitor of performance-related data associated with execution of the application 112 on the mobile device 100 and for retrieving performance-related data accessible using the second level of permissions/privileges (e.g. shell level of permissions or higher application level of permissions/privileges). Proceed to A3.
A3. Retrieving and storing performance related data from one or more of:
   a) the performance monitoring component associated with performance-related data only accessible from the OS 114 using the second level of permissions/privileges;
   b) the performance monitoring component associated with some or all of the performance-related data using the second level of permissions/privileges; and/or
   c) performance retrieval threads instantiated by the diagnostic application 116 for retrieving some or all performance-related data that is accessible from the OS 114 using a first level of permissions/privileges (e.g. an application level of permissions/privileges).
   Proceed to A4.
A4. Determine whether to continue to monitor application 112a executing on mobile device 100 (e.g. the application 112a may have finished execution, enough performance-related data has been collected in relation to the application 112a). If it is determined to continue monitoring application proceed to A3, otherwise proceed to A5.
A5. Send terminate monitoring instruction/request to performance monitoring application 118. Proceed to A6.
A6. Perform at least one of the following:
   a) send stored performance-related data to another computing device or server for analysis of the performance of the application 112a executing on the mobile device 100 (e.g. send to a cloud system for analysis and/or presentation of results/performance statistics, or send to another computing device for analysis and presentation of results/performance statistics); and/or
   b) Analyse the stored performance-related data and present/display performance results/performance statistics of the application 112a executing on the mobile device 100 to the user of the mobile device 100; and/or
   c) Analyse the stored performance-related data to generate one or more usage parameters such as performance statistics/parameters for the application 112a and storing in a usage profile for the application.

Although steps A3-A6 have been described above in a particular order, it is to be appreciated by the skilled person that the steps of A6 may be merged with A3, or be performed, for example, concurrently with the steps A2-A3. For example, instead of waiting to terminate the monitoring process etc. before performing step A6, step A6 may be performed prior to steps A4 or A5. For example, step A3 may be modified to include: a) sending stored performance-related data to another computing device or server for analysis of the application 112a executing on the mobile device 100 (e.g. send to a cloud system for analysis and/or presentation of results, or send to another computing device for analysis and presentation of results); and/or analysing the stored performance-related data and present performance results of the application 112a executing on the mobile device 100 to the user of the mobile device 100; and/or analyse the stored performance-related data to generate one or more usage parameters for the application 112a and storing in a usage profile for the application. Thus performance statistics/parameters may be calculated during execution of the application 112a or applications 112 on the mobile device 100, which may be used in a feedback loop to optimise the performance of the mobile device 100.

FIG. 1d is a flow diagram illustrating an example process for a performance monitoring component 118 according to an embodiment, for example, the performance monitoring component 118 as described in relation to FIGS. 1a and 1c. The mobile device 100 may include a storage unit 104 such as a memory or computer readable medium that includes computer readable instructions associated with one or more applications 112a, 112 an operating system 114, a diagnostic application 116 and the performance monitoring component 118. The diagnostic application 116, which when executed on the processing unit 102 of the mobile device 100 has a first level of permissions/privileges, and performs, by way of example, a process for monitoring and/or analysing (e.g. benchmarking) the performance of an application 112a for execution on the mobile device 100 as described with respect to FIGS. 1a-1c. The performance monitoring component 118, which when executed on the processing unit 102 has a second level of permissions/privileges (e.g. a higher level of permissions/privileges or a shell level of permissions/privileges), where the second level of permissions/privileges provide further permissions/privileges for accessing hardware of the mobile device 100 than that provided by the first level of permissions/privileges, and performs, by way of example, a process for monitoring the performance of an application 112a for execution on the mobile device 100 based on the following:
B1. After the performance monitoring component 118 has launched, it is initialised and executes as a background process on the mobile device 100, and enters a wait state.
B2. Determine whether a monitoring request/instruction for an application 112a to execute on mobile device 100 has been received from the diagnostic component 116. If a monitoring request/instruction has been received, then enter the monitoring state and proceed to B3, otherwise remain in the wait state and proceed to B1.
B3. Initialise functionality of OS 114 to allow monitoring of performance-related data in relation to execution of application 112a on the mobile device 100. For example, the performance monitoring component 118 may instruct the OS 114 or components thereof to perform debugging/trace functionality for output trace results as the application 112a executes on the mobile device 100. Proceed to B4.
B4. Retrieve and/or store performance-related data from one or more of:
   a) filtering output of trace results for performance-related data associated with performance-related data only accessible from the OS 114 using the second level of permissions/privileges;
   b) the performance monitoring component 118 associated with some or all of the performance-related data using the second level of permissions/privileges; and/or
   c) performance retrieval thread(s) instantiated by the performance monitoring component 118 for retrieving some or all performance-related data that is accessible from the OS 114 using an second level of permissions/privileges; and/or
   d) performance retrieval thread(s) instantiated by the performance monitoring component 118 for retrieving only the performance-related data that is accessible from the OS 114 using a second level of permissions/privileges and which is inaccessible using the first level of permissions/privileges.

Proceed to B5.
B5. Send any retrieved/stored performance-related data to the diagnostic application 116. Proceed to B6.
B6. Determine whether a terminate instruction/request from the diagnostic application 116 is received. If a terminate instruction/request is received then proceed to B7, otherwise proceed to B4.
B7. Terminate execution of functionality of OS 114 that allows monitoring of performance-related data in relation to execution of application 112a on the mobile device 100. For example, the performance monitoring component 118 may instruct the OS 114 or components thereof to terminate or stop debugging/trace functionality that output trace results as the application 112a executes on the mobile device 100. Proceed to B1 to reset performance monitoring component 118 and enter the wait state.

Although the diagnostic application 116 and performance monitoring component 118 have been described in relation to monitoring and retrieving performance-related data associated with an application 112a executing on the mobile device 100, it is to be appreciated by the skilled person that the diagnostic application 116 and/or performance monitoring component 118 may be further configured to implement a performance/adjustment feedback loop based on monitoring and retrieving performance-related data associated with one or more applications 112 and adjusting the operating point(s) of the hardware of the mobile device 100 based on parameters/statistics output from a performance analysis of the retrieved performance-related data to adaptively optimise the performance of the mobile device 100 and/or the one or more applications 112 executing on the mobile device 100. The parameters/statistics output from the performance analysis of the retrieved performance-related data may be performed by the diagnostic application 116. performance monitoring component 118, and/or a server or host computing system configured to perform the performance analysis on the retrieved performance-related data and provide performance statistics/parameters to the mobile device 100 (e.g. to the diagnostic application 116 and/or performance monitoring component 118).

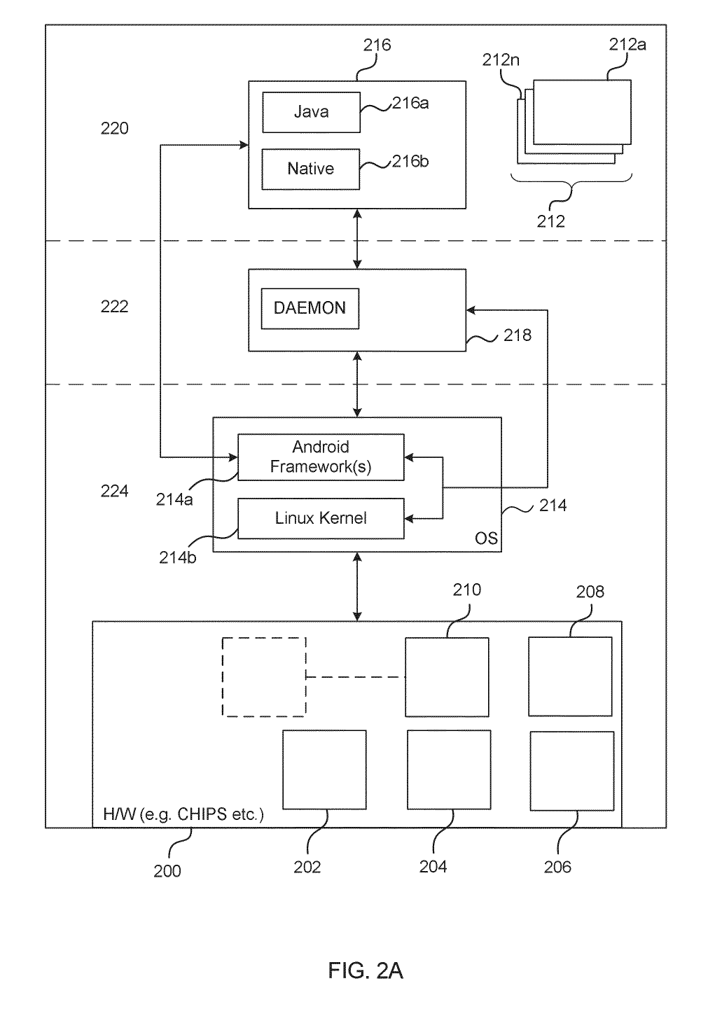

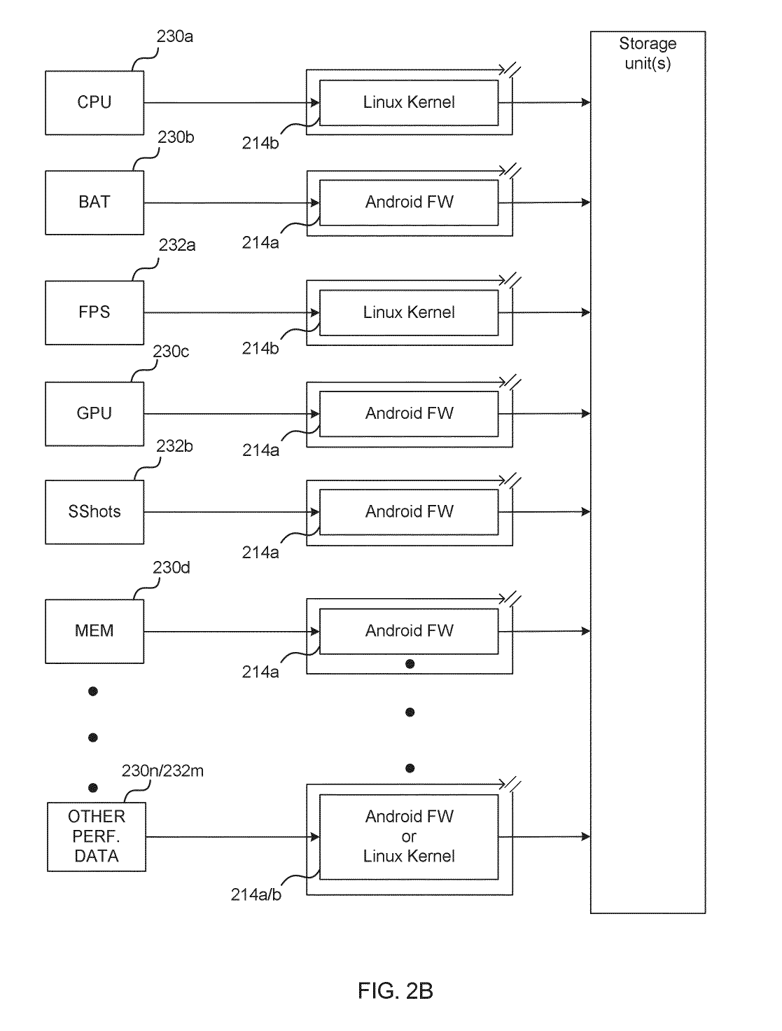

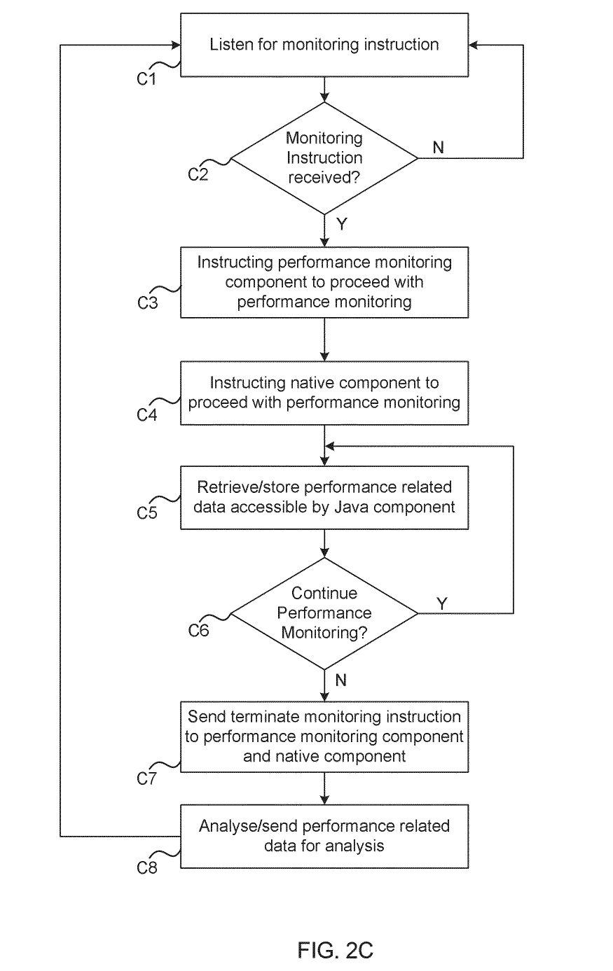

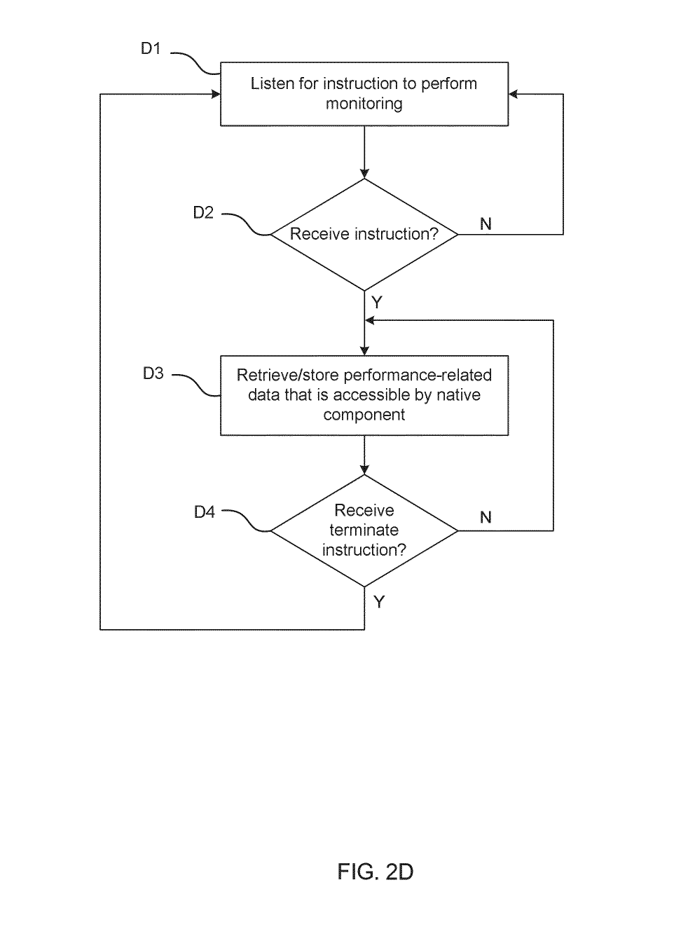

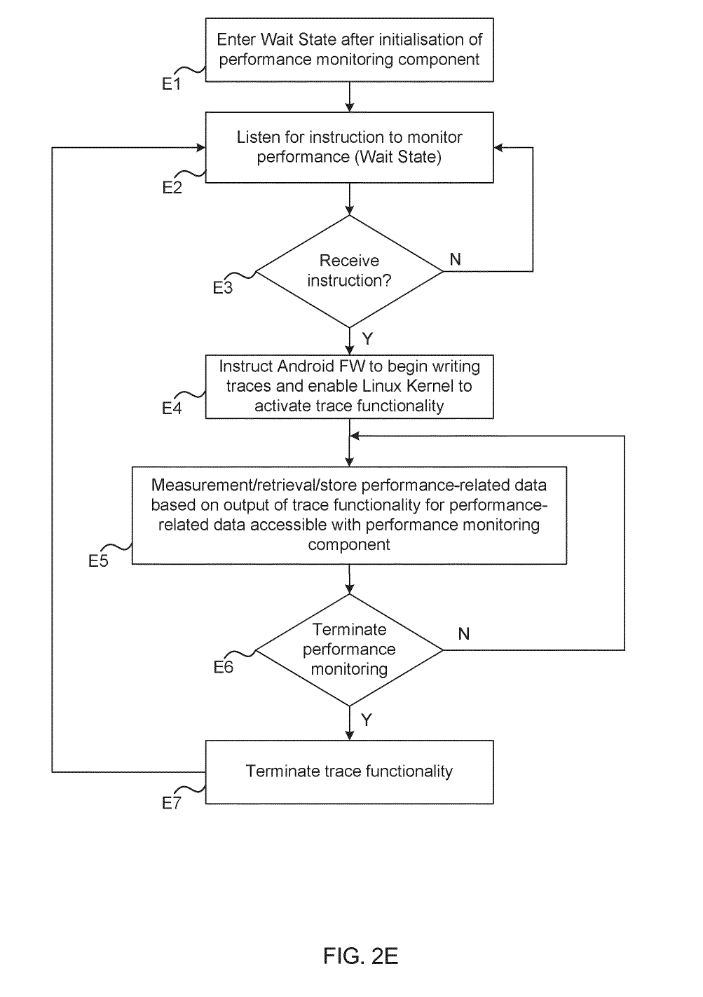

FIG. 2a is a schematic diagram illustrating an example benchmarking system for a mobile device 200 based on the Android®OS according to embodiments. Android® is a mobile OS for mobile devices 200 that is based on the Linux kernel and currently developed by Google®. The mobile device 200 includes hardware such as a processing unit 202, a storage unit 204, an input/output unit 206, a receiver 208 and a transmitter 210, in which the processing unit 202 is coupled to the storage unit 204, the I/O unit 206, the receiver 208 and transmitter 210.

The storage unit 204 may include one or more for computer readable mediums (e.g. solid-state or flash memory, random access memory, read only memory, hard-disk drive, optical disc) for use in storing program instructions associated with a plurality of applications 212 (e.g. applications 212a-212n that may include games, social networking applications, spreadsheets, utility applications, word processing, email, web browsers, calendars, address books, and any other user application program configured for execution on processing unit 202, etc.), an operating system 214 (OS) based on the Android OS, a diagnostic application 216 (e.g. a GameBench App downloadable from the Google Play Store®) and a performance monitoring component or daemon 218.

In this example, the OS 214 is an Android OS 214 that includes two components, Android Frameworks 214a and the Linux Kernel 214b. The Android Frameworks 214a is the set of application programming interfaces (APIs) that allow applications to communicate with the Android OS 214 and the Linux Kernel 214b, which manages input/output requests from software, and translates them into data processing instructions for the processing unit 202 or storage unit 204 (e.g. CPU or memory) and other hardware/system components of the mobile device 200. The Linux kernel 214b is the fundamental part of the Android OS 214. In essence, the Linux Kernel 214b runs on the mobile device 200 and communicates with the underlying hardware/chip of the mobile device 200.

The diagnostic application 216 and the performance monitoring component 218 may be configured for use in performing one or more functions associated with benchmarking, performance monitoring, system monitoring, security monitoring, performance analysis, system optimisation, security risk assessment of one or more applications executing on the mobile device 200. The diagnostic application 216 uses debugging permissions/privileges to, by way of example only but not limited to, monitor and control operating points of the mobile device 200. The diagnostic application 216 can be used to profile applications 212 stored in storage unit 204 (e.g. games) that can be executed on processing unit 202 of mobile device 200.

The applications 212 and 216 may be downloaded from an application developer and/or content provider (e.g. the Google Play Store). The diagnostic application 216 is used to understand the real world performance of mobile devices (e.g. real world performance of mobile devices running Android OS). The diagnostic application 216 can also serve as a usability test for a mobile device 200 or a usability test for potential applications on the mobile device 200. This allows the user of the mobile device 200 or the developer of an application to compare a set of mobile devices based on real-world applications 212 and/or content. This also allows the user of the mobile device 200 or the developer of an application 212a to assess the performance of the application against a set of similar applications on the mobile device 200.

The levels of permissions/privileges that are provided to applications 212 or 216, components 218 and the OS 214 under the Android OS 114 are: a) sandbox or application; b) shell; and c) administrator. The sandbox or application level of permissions/privileges 220 is a first level of permissions/privileges that (e.g. application level of permissions/privileges) are typically given to all installed applications 212 and 216. Applications 212 and 216 with sandbox level of permissions/privileges 220 are able to access services from the Android OS 214, but they cannot rewrite crucial parts of the OS 214 or use certain low level features used for debugging. The shell level of permissions/privileges 222 is a second level of permissions/privileges that allow a binary component or background process such as performance monitoring component 218 to get access to some features in the Linux kernel of the OS 214 that are not accessible by applications 212 and 216, which have only application level of permissions/privileges 220. The administrator level of permissions/privileges 224 (e.g. full level of permissions/privileges) provides the full level of access to the OS 214 and underlying hardware/system of the mobile device 200. For example, with the administrator level of permissions/privileges a user can wipe the complete OS 214 from the mobile device 200 or have full read/write/executable access to any hardware/system/component/application/data of the mobile device 200. Administrator level of permissions/privileges is equivalent to “sudo” in Linux.

The diagnostic application 216 includes a Java® component 216a and a native component 216b, which together form the diagnostic application 216. The plurality of applications 212 and diagnostic application 216, which when executed on the processing unit 202, are configured to have an application level of permissions/privileges 220 (e.g. sandbox permissions/privileges) for accessing the OS 214 and subsequent hardware of the mobile device 200. The applications 212 and diagnostic application 216 are Android applications that execute in a sandboxed environment (e.g. an isolated area of the mobile device 200 that does not have access to the rest of the mobile device's 200 resources), unless certain access permissions/privileges that are within the application level of permissions/privileges are explicitly granted by the user when the application is installed.

In essence, the diagnostic application 216 relies on sandbox level of permissions/privileges 220 and also shell level of permissions/privileges 222 via performance monitoring component 218 for measuring and collecting important performance-related data and information about performance and power consumption of mobile device 200. This performance-related data can be used for understanding the real world performance of the mobile device 200 for commonly used applications 212, and/or change the operating points of the mobile device 200 based on the collected performance-related data. As described above, the diagnostic application 216 operates in conjunction with the performance monitoring/measuring component 218 (e.g. a daemon), which is launched on the mobile device 200 with higher level of permissions/privileges than the diagnostic application 216 (e.g. Android Debug Bridge (ADB) Shell permissions/privileges).

The diagnostic application 216 may execute as a background process on the mobile device 200. The Java component 216a of the diagnostic application 216 is primarily responsible for starting/stopping the data collection. When a user launches an application 212a (e.g. starts recording performance-related data), the Java component 216 may perform one or more of the following functions, some of which may be performed concurrently:
Informs the native component 216b of the diagnostic application 216 and the performance monitoring component 218 to begin measurements of performance-related data (e.g. CPU, GPU, battery consumption/usage, FPS, Screen Shots etc.) associated with the execution of the application 212a;
Listens for the user to issue an instruction to terminate the performance monitoring (e.g. to stop recording performance-related data), or for the application 212a to terminate;
Instantiating performance retrieval execution threads for retrieving some or all performance-related data accessible by the Java component 216a;
Stores performance-related data using the native component 216b to storage unit 204 (e.g. flash memory or disk, etc.);
Retrieves performance-related data from the performance monitoring component 218 (e.g. the daemon) and stores the performance-related data to storage unit 204 (e.g. flash memory or disk, etc.).
Informs the native component 216b and performance monitoring component 218 to terminate monitoring performance-related data when instruction received to terminate or when application detected as terminating.

The Java component 216a also measures and retrieves some of the performance-related data (e.g. mobile device parameters) that are specific or readily available using the Android layer (or Android Framework). For example, in the current Android OS 214, the shell level of permissions/privileges is not required to measure battery consumption/usage, CPU usage, or GPU usage, which can be returned by the Android Framework and are thus accessible to the Java component 216a. The Java component 216a may instantiate one or more performance retrieval execution threads for measuring and retrieving performance-related data associated with each thread.

The native component 216b (written in C++), once notified by the Java component 216a to being measuring and retrieving performance-related data, performs measurements and retrieval of the performance-related data that cannot be performed using the Java component 216a. For example, the native component 216b may instantiate one or more performance retrieval execution thread(s) that may communicate with the graphics processing unit (GPU) driver and retrieve performance-related data such as hardware statistics. An advantage of the native component 216b is that it is written in C++, which means it can consume less CPU cycles compared to the Java component 216a. Further efficiency gains (in terms of CPU cycles) may be made by configuring the native component 216b to also retrieve performance-related data that the Java component 216a is able to retrieve, which will further minimise the impact the diagnostic application 216 may have on the performance of the mobile device 200. For example, although the Java component 216a may be able to measure and retrieve performance-related data associated with the GPU, the native component 216b may instead be configured to retrieve performance-related data associated with the GPU. The native component 216b may also deal with storing the performance-related data collected by the diagnostic application 216 and retrieved from the performance monitoring component 218.

The performance monitoring component 218 (e.g. daemon component) is responsible for initiating the collection of performance-related data by the Java component 216a, native component 216b, and performance monitoring component 218. The performance monitoring component 218 may be configured to collect performance-related data that is not accessible using either the Java component 216a or native component 216b of the diagnostic application. For example, the performance monitoring component may measure and retrieve performance-related data associated with frames-per-second (FPS) and/or screenshots (e.g. collecting screenshots every second) of the display during execution of the application 212a. For example, to collect screenshots, the performance monitoring component 218 uses the Android infrastructure (e.g. Surface Flinger) and dumps the contents of the screen every second to the storage unit 204 (e.g. internal memory or storage) or to the diagnostic application 216 for storage in storage unit 204. The performance monitoring component 218 may be extended to add any other measurements of performance-related data that may be relevant now and in the future to diagnostic application 216.

The performance-monitoring component 218 may collect performance-related data, which may be inaccessible to the diagnostic application 216 or not available to the diagnostic application 216 at a desired granularity or as in-depth as needed, by using the tracing infrastructure of the Linux kernel 214b. However, initiating the tracing infrastructure requires at least the shell level of permissions/privileges (e.g. ADB Shell permissions/privileges), which neither the diagnostic application 216 has via either the Java component 216a or native component 216b. Instead, the performance monitoring component 218 (or daemon component) may perform one or more of the following functions (some of which may be performed concurrently):
Listen for an instruction (e.g. a monitoring instruction or request) from the Java component 216a to start measurements of performance-related data;
When the instruction is received, turn on certain flags in the Android framework to get tracing information; and
Parse the trace looking for performance tags associated with performance-related data. For example, the trace pipe may be consumed by performance retrieval threads instantiated by the performance monitoring component 218 (e.g. the daemon). The threads instantiated by the diagnostic application 216 cannot consume the trace pipe because the diagnostic application 216 has only application level of permissions/privileges 220;
Store the performance-related data or information and periodically send or communicate it to the Java component 216a of the diagnostic application 216;
Listen for a terminate instruction from the Java component 216a, and when terminate instruction received to turn off certain flags in the Android framework to stop getting tracing information; and
Once the measurements are done/terminated, the performance monitoring component enters a wait state (or sleep state) waiting for any further instructions communicated from the Java component 216a.

Thus, it is the synergetic relationship between the diagnostic application 216 and performance monitoring component 218 that allows measurement and collection of enough performance-related data of an application for execution on the mobile device 200 that may be analysed to determine the performance of the mobile device 200 when executing the application 212. For example, the performance-related data that is collected by the diagnostic application 216 may be analysed to output performance statistics/parameters, which may be used to display performance of the mobile device 200 and application 212a executing on the mobile device 200 to the user and/or for adjusting/optimizing the performance of the mobile device 200 during execution of the application 212a. The parameters/statistics output from the performance analysis of the retrieved performance-related data may be performed by the diagnostic application 216 and/or performance monitoring component 218. Alternatively, the retrieved performance-related data may be sent using receiver 208/transmitter 210 to a server or host computing system configured to perform the performance analysis on the retrieved performance-related data and provide performance statistics/parameters to the mobile device 200 (e.g. to the diagnostic application 216 and/or performance monitoring component 218, or any other suitable application).

Although the diagnostic application 216 and performance monitoring component 218 have been described, by way of example only, in relation to monitoring and retrieving performance-related data associated with an application 212a executing on the mobile device 200, it is to be appreciated by the skilled person that the diagnostic application 216 and/or performance monitoring component 218 may be further configured to implement, by way of example, a performance/adjustment feedback loop based on monitoring and retrieving performance-related data associated with one or more applications 212 and adjusting the operating point(s) of the hardware of the mobile device 200 based on parameters/statistics output from a performance analysis of the retrieved performance-related data to adaptively optimise the performance of the mobile device 200 and/or the one or more applications 212 executing on the mobile device 200.

Once the monitoring instruction or request is received by the performance monitoring component 218, the performance monitoring component 218 activates a debugging/tracing function associated with the Android Frameworks that outputs debugging/tracing information associated with execution of the application 212a on the mobile device 200. As well, the performance monitoring component 218 activates or enables a debug/trace functionality associated with the Linux Kernel component 216b. The trace function generates a trace pipe that receives trace/debugging information for outputting trace data.

For example, a sample of the output trace data from the trace pipe may be as follows:

< . . . >-2543 [001] . . . 1 59950.714628: tracing_mark_write: B|2543|merge
< . . . >-2543 [001] . . . 1 59950.714673: tracing_mark_write: E
< . . . >-2543 [001] . . . 1 59950.714702: tracing_mark_write: E
< . . . >-2543 [001] . . . 1 59950.714710: tracing_mark_write: E
< . . . >-2543 [001] . . . 1 59950.714817: tracing_mark_write: E
< . . . >-2543 [001] . . . 1 59950.714826: tracing_mark_write: E
< . . . >-2645 [002] . . . 1 59950.717522: tracing_mark_write: C|2543|HW_VSYNC_0|0
< . . . >-2659 [003] . . . 1 59950.717922: tracing_mark_write: C|2543|VsyncOn|0
< . . . >-30765 [001] . . . 1 59950.728982: tracing_mark_write: B|30707|eglSwapBuffers
< . . . >-30765 [001] . . . 1 59950.729092: tracing_mark_write: B|30707|setBuffersTransform
< . . . >-30765 [001] . . . 1 59950.729104: tracing_mark_write: E
< . . . >-30765 [001] . . . 1 59950.729119: tracing_mark_write: B|30707|queueBuffer

In this example, the output trace data has timestamps denoted, 59950.xxxxxx, and a plurality of trace markers (e.g. setBuffersTransform, eglSwapBuffers, queueBuffer, etc.), which may be suitable for and used as performance-related data. For example, the output trace data associated with eglSwapBuffers may be used to calculate the frames per second (FPS). Although several trace markers are shown above, it is to be appreciated by the skilled person that there are a multitude or a plurality of trace markers that may be used or applied for deriving, retrieving performance-related data for monitoring, analysis and/or use in optimising the performance of the mobile device according to embodiments.

The performance monitoring component 218 scans the trace data output and trace markers therein for detecting performance tags/markers or trace performance data associated with the performance-related data. The performance monitoring component 218 then stores and sends the performance-related data associated with the detected performance tags to the Java component 216a of the diagnostic application 216.

FIG. 2b is a schematic diagram further illustrating monitoring and retrieving performance-related data according to an embodiment. Once the Java component 216a informs the native component 216b and the performance monitoring component 218 to start monitoring/measuring and retrieving performance related data, the performance monitoring component 218 then initiates/activates trace functionality in the Android OS 214 in the Android Framework 214a and the Linux kernel 214b. These two operations enable the measurement and retrieval of performance-related data.

As mentioned above, the Java component 216a can be configured to measure and retrieve performance-related data associated with CPU performance (e.g. CPU performance-related data), battery consumption/usage (e.g. battery performance-related data), GPU performance (e.g. GPU performance-related data), memory consumption/usage (e.g. memory performance-related data), and any other performance-related data that may be required or desired to be measured/retrieved from the various hardware components/software of the mobile device 200. The performance-related data may be analysed/converted into the required or desired performance statistics/parameters associated with the performance of the mobile device 200.

The Java component 216a, which only has application level of permissions/privileges 220, may implement threaded execution of multiple performance retrieval threads 230a-230n for retrieval of each type of performance-related data that is accessible to it. In the example illustrated in FIG. 2b, multiple threads 230a-230n will exist during retrieval and storage of the performance-related data, each thread related to retrieval of a different type or portion of the performance-related data. By way of example only, the Java component 216a instantiates a CPU performance retrieval thread 230a, a battery usage retrieval thread 230b, a GPU performance retrieval thread 230c, a memory usage retrieval thread 230d, and, if required, any other performance-related retrieval thread 230n.

The CPU performance retrieval thread 230a communicates with the Linux kernel 214b to periodically (e.g. 1 s) retrieve CPU performance-related data for storage in storage unit 204. The battery usage retrieval thread 230b communicates with the Android Framework 214a to periodically (e.g. 30 s) retrieve battery usage performance-related data for storage in storage unit 204. The GPU performance retrieval thread 230c communicates with the Android Framework 214a to periodically retrieve GPU performance-related data for storage in storage unit 204. The memory usage retrieval thread 230d communicates with the Android Framework 214a to periodically retrieve memory usage performance-related data for storage in storage unit 204. If required, any other performance-related retrieval thread 230n communicates with either the Android Framework 214a and/or the Linux kernel 214b to periodically retrieve other performance-related data for storage in storage unit 204.

For example, the CPU performance retrieval thread 230a may be configured to measure CPU performance-related data on the CPU usage using the /proc/filesystem in Linux to get CPU usage statistics of a process (e.g. the application 212a). The CPU performance retrieval thread 230a may read a file called /proc/stat typically includes several entries about overall CPU usage. The CPU performance retrieval thread 230a may also read a file called /proc/{pid}/stat with the {pid} being the process identity (or id) assigned by Linux to an application such as the application 212a, will contain statistics about the application 212a (or profiled application/process). CPU performance retrieval thread 230a may read each of these files periodically to get a trend of CPU performance statistics/parameters such as CPU Usage for the application 212a.

For example, CPU performance statistics/parameters such as CPU usage may be calculated from the files /proc/stat and /proc/{pid}/stat. For a particular instance of time on the mobile device, the file /proc/stat may include by way of example only, the following CPU data:
cpu 1418005 366163 1449665 15430848 50209 888 45347 0 0 0
   where the first field (1418005) represents total user time, and the third field (1449665) represents total system time. For an application associated with {pid} executing at a particular instance of time on the mobile device, the file /proc/{pid}/stat may include, by way of example only, the following CPU data:

### 30707 (.ANMP.GloftDMHM) R 2544 2544 0 0 −1 4194624 332221 0 6206 0 47994 26210 0 0 20 0 78 0 13089874 1290149888 34785 4294967295 1 1 0 0 0 0 4612 0 38136 4294967295 0 0 17 2 0 0 0 0 0 0 0 0

where the 14^{th} and 15^{th} fields represent the process user time and the process system time.

The CPU Usage may be calculated from /proc/stat and /proc/{pid}/stat using the equation:

CPU Usage=((pu2−pu1)+(ps2−ps1))/((ts2−ts1)+(tu2−tu1)),

where, if the files are sampled every second, then tu1 is the total user time at n seconds, ts1 is the total system time at n seconds, tu2 is the total user time at n+1 seconds, ts2 is the total system time at n+1 seconds, pu1 is the process {pid} user time at n seconds, ps1 is the process {pid} system time at n seconds, pu2 is the process {pid} user time at n+1 seconds, and ps2 is the process {pid} system time at n+1 seconds. It is to be appreciated that the files may be sampled at any time other than every second.

For example, the CPU performance retrieval thread 230a may be configured to measure CPU performance-related data associated with CPU Frequency for individual cores while the application 212a is profiled/executed on the mobile device 100, which may be measured/analysed or converted into CPU performance statistics/parameters. As Linux has a /sys/filesystem, the CPU performance retrieval thread 230a may profile/read this file system for various CPU performance statistics/parameters like CPU on/off, CPU Scaling frequencies, operating frequencies etc., e.g. the file /sys/devices/system/cpu/cpu0/online may be read to provide the online state of the core-0 of the CPU.

Examples of CPU performance statistics derived from an analysis of CPU performance-related data is illustrated in FIGS. 4a and 4d. As previously described, FIG. 4a illustrates an example dashboard 400 output of a performance analysis of, by way of example only, mobile device 200 when it is an Amazon KFTGWI handset 402 based on monitoring performance-related data during execution of an application such as game application 404 called Dead Trigger®. The CPU performance-related data may be analysed to provide CPU performance statistic(s) 410 (e.g. CPU usage of the application such as median CPU usage of the application as a percentage, in this case, 31.31%). In addition to the median CPU usage, other CPU performance statistics may be presented as illustrated in FIG. 4d.

FIG. 4d illustrates a CPU Overall Usage performance statistics 410a and CPU Core Usage performance statistics 410b derived from the CPU performance-related data. The CPU Overall Usage performance statistics 410a illustrates, by way of example only, a CPU usage graph of the overall CPU usage (%) vs time (secs), the CPU Overall Usage is represented by the solid line with solid circles. The CPU Core Usage performance statistics 410b illustrates a graph of the four CPU Cores (e.g. CPU Core 1 usage 411a, CPU Core 2 usage 411b, CPU Core 3 usage 411c, and CPU Core 4 usage 411d) of the processor 202 of the mobile device 200 when it is an Amazon KFTGWI handset 402.

For example, the GPU performance retrieval thread 230c may be configured to measure performance-related data for the GPU based on the type of access to the GPU that each manufacturer allows. For example, for QUALCOMM®GPUs (e.g. Adreno), the GPU performance retrieval thread 230c may profile/read a /sys/file (e.g. /sys/class/kgsl/kgsl-3d0/gpubusy), that includes GPU performance-related data for inferring GPU performance statistics such as GPU Utilisation. For Nvidia®GPUs, the GPU utilization may be measured by the GPU performance retrieval thread 230c also using a /sys/file. Alternatively, in another example, for Imagination®GPUs, a Software Development Kit (SDK) called PVRScope may be provided that requires a shell level of permissions/privileges 222, which may require a GPU performance retrieval thread (not shown) to be instantiated by the performance monitoring component 218. This GPU performance retrieval thread may be configured to use PVRScope to turn on certain hardware counters that provide GPU Usage information, which reads/filters the performance-related data for the GPU and sends this to the diagnostic application 216.

Examples of GPU performance statistics derived from an analysis of GPU performance-related data is illustrated in FIGS. 4a and 4e. The GPU performance-related data may be analysed to provide GPU performance statistic(s) 412 (e.g. GPU usage of the application such as median GPU usage as a percentage, in this case, 69.97%). In addition to the median GPU usage, other GPU performance statistics may be presented as illustrated in FIG. 4e. FIG. 4e illustrates a GPU Usage performance statistics 412a and GPU Clock Speed (MHz) performance statistics 412b derived from the GPU performance-related data. The GPU Usage performance statistics 412a illustrates, by way of example only, a GPU usage graph of the GPU usage (%) vs time (secs), the GPU Usage is represented by the solid line with solid circles. The GPU Clock Speed performance statistics 412b illustrates a graph of the GPU Clock speed (MHz) of the GPU processor of the mobile device 200 when it is an Amazon KFTGWI handset 402. In this example, this graph illustrates the changes in the GPU processor clock speed within the range 200 MHz to 400 MHz.

For example, the memory usage retrieval thread 230d may be configured to measure performance-related data associated with memory performance statistics/parameters such as memory or storage consumption or usage of storage unit 204 of the mobile device 100. This may be based on reports of memory usage of all running applications/processes on the mobile device 200. For example, the memory usage retrieval thread 230d may be configured to use an API provided by Android that can be used for reporting on memory usage of all the running processes/applications on mobile device 200. This API may be called periodically to analyse and determine the total RAM usage of the application 212a that is executed/profiled on the mobile device 200.

Examples of memory performance statistics derived from an analysis of memory performance-related data are illustrated in FIGS. 4a and 4f. The memory performance-related data may be analysed to provide memory performance statistic(s) 414 (e.g. memory usage such as median memory usage in megabytes (MB), in this case, 168 MB). In addition to the median memory usage, other memory performance statistics may be presented as illustrated in FIG. 4f. FIG. 4f illustrates a memory usage performance statistics 414a derived from the memory performance-related data. The memory usage performance statistics 414a illustrates, by way of example only, a memory usage graph of the overall memory usage in Megabytes (MB) vs time (secs). The memory usage for each process on the mobile device 200, when it is an Amazon KFTGWI handset 402, is represented by lines 414b-414e. Although the median memory usage was 168 MB for the application 404 as illustrated in FIG. 4a, the memory usage illustrated in FIG. 4f of the mobile device 200 during execution of the application 404 is for a short time window of the execution period of the application 404, and so has not yet reached a median value of 168 MB.

For example, the battery usage retrieval thread 230b may be configured to measure performance-related data associated with the battery performance statistics/parameters such as battery or power consumption or usage of battery or power source of the mobile device 200. The battery usage retrieval thread 230b may call an Android API that measures the battery once every n seconds (e.g. 30 seconds). Alternatively or additionally, the performance monitoring component 218 instantiate a battery usage retrieval thread (not shown) to use its shell level of privileges/permissions to consume relevant data from the trace pipe and/or measure detailed statistics for the battery such as, by way of example only, current/voltage etc.

Examples of battery performance statistics derived from an analysis of battery performance-related data is illustrated in FIGS. 4a and 4c. The battery performance-related data may be analysed to provide battery performance statistic(s) 408 (e.g. Battery life (hh:mm) of 03 hours and 46 minutes). In addition to the battery life, other battery performance statistics may be presented as illustrated in FIG. 4c. FIG. 4c is an illustration of an example output of a battery performance analysis of the mobile device 200 when it is an Amazon KFTGWI handset 402 based on battery performance-related data retrieved. FIG. 4c illustrates battery level performance statistics 408a derived from the battery performance-related data. The battery level performance statistics 408a illustrates, by way of example only, a graph of the battery level as a percentage of overall battery capacity vs time (minutes) during execution of the application 404. The battery level began at 92% and was drained down to a battery level between 84% and 83%. FIG. 4c also illustrates battery temperature performance statistics 408b derived from the battery performance-related data. The battery temperature performance statistics 408b illustrates, by way of example only, a graph of the battery temperature in degrees Celsius (deg. C) vs time (minutes) during execution of the application 404. The battery temperature began at 30 degrees Celsius and stepped up to 39 degrees Celsius due to the performance demands on the battery by the GPU, CPU, display etc.

Similarly, the performance monitoring component 218 can be configured to measure and retrieve performance-related data associated with screen shots and/or frames-per-second performance, and any other performance-related data that may be analysed/converted into the required or desired performance statistics/parameters associated with the performance of the mobile device 200. The performance monitoring component 218, which has higher level of permissions/privileges 222 (e.g. shell level of permissions/privileges), may also implement threaded execution of multiple performance retrieval threads 232a-232m for retrieval of each type of performance-related data that may be required to be retrieved by the performance monitoring component 218. In the example illustrated in FIG. 2b, multiple threads 232a-232m will exist during retrieval and storage of the performance-related data, each thread related to retrieval of a different type or portion of the performance-related data. By way of example only, the performance monitoring component 218 instantiates a frames-per-second performance retrieval thread 232a and a screen shot retrieval thread 232b, and, if required, any other performance-related retrieval thread 232m.

Examples of screen shot performance statistics based on the performance data associated with screen shots is illustrated in FIG. 4a, in which the dashboard 400 also includes a screenshot player 416 that may play the performance-related data associated with screenshots gathered by the performance monitoring component 218 during execution of the application 404 on the mobile device 200 when it is an Amazon KFTGWI handset 402.

The frames-per-second (FPS) performance retrieval thread 232a communicates with the Linux kernel 214b to periodically (e.g. ( 1/60) s or 60 Hz) retrieve FPS performance-related data for storage in storage unit 204. The screen shot retrieval thread 232b communicates with the Android Framework 214a to periodically retrieve screen shot performance-related data for storage in storage unit 204. If required, any other performance-related retrieval thread 230m communicates with either the Android Framework 214a and/or the Linux kernel 214b to periodically retrieve other performance-related data for storage in storage unit 204.

Examples of FPS performance statistics derived from an analysis of FPS performance-related data is illustrated in FIGS. 4a and 4b. The FPS performance-related data may be analysed to provide an FPS performance statistic(s) 406 (e.g. median FPS of 60 fps). In addition to the median FPS, other FPS performance statistics may be presented as illustrated in FIG. 4b. FIG. 4b is an illustration of an example output of a FPS performance analysis of the mobile device 200 when it is an Amazon KFTGWI handset 402 based on FPS performance-related data retrieved. FIG. 4b illustrates real-time FPS performance statistics 406a derived from the FPS performance-related data against the median FPS 406 of 60 fps. The real-time FPS performance statistics 406a illustrates, by way of example only, a graph of the FPS vs time (minutes) during execution of the application 404. FIG. 4b also illustrates FPS Stability performance statistics 406b derived from the FPS performance-related data. The FPS stability performance statistics 406b illustrates, by way of example only, the “spread” of FPS during execution of the application 404.

It is to be appreciated that the native component 216b can also be configured to measure and retrieve performance-related data, for example, performance-related data associated with GPU performance and any other performance-related data that may be required. The native component 216b is written in C++, which uses less CPU cycles than Java to execute. The native component 216b, which only has application level of permissions/privileges 220, can implement threaded execution of one or more of the performance retrieval threads 230a-230n as described in relation to the Java component 216a for retrieval of each type of performance-related data that is accessible to it. In the example illustrated in FIG. 2b, multiple threads 230a-230n will exist during retrieval and storage of the performance-related data, each thread related to retrieval of a different type or portion of the performance-related data. The native component 216b may, by way of example only, instantiate a GPU performance retrieval thread 230c and, if required, any other performance-related retrieval thread 230a-230n. The GPU performance retrieval thread 230c may communicate with the Android Framework 214a to periodically retrieve GPU performance-related data for storage in storage unit 204. If required, any other performance-related retrieval thread 230a-230n may communicate with either the Android Framework 214a and/or the Linux kernel 214b to periodically retrieve other performance-related data for storage in storage unit 204.

The performance-related data stored by the multiple threads 230a-230n and 232a-232m in storage unit 204 may be analysed by the mobile device 200, and a summary of the analysis results (e.g. performance-related statistics/parameters) may be presented to the user via the display of the mobile device 200. This provides the advantage that the stored performance-related data may be immediately analysed or analysed concurrently to the retrieval of the performance-related data and presented to the user or used to adjust the performance of the mobile device 200 during execution of the application 212a; that is, no cloud based service is necessary for communicating and analysing the stored performance-related data presenting the results to the user. However, the display of a mobile device 200 is typically small and can be difficult to visualise the analytical results, or the analysis may consume too many resources of the mobile device 200. Instead, the mobile device 200 may transmit the stored performance-related data to over a communication network to a server (e.g. cloud based storage solution or a cloud based performance analysis system) for a more detailed performance analysis of the application 212a and mobile device 200. The server may then present the performance analysis results (e.g. performance-related statistics/parameters) to the user via the diagnostic application 216, a web browser or any other application. This provides the advantages that various mobile devices may be compared against mobile device 200 when executing the same application 212a; or the execution of various applications may be compared for the same mobile device 200, such may assist the user in selecting and/or purchasing the most suitable application 212a for use on the mobile device 200. Further advantages include storage of historical performance-related data associated with the application 212a and access to the analysis results and stored performance-related data from anywhere and at any time. Alternatively or additionally, the stored performance-related data may be sent to a computing device with a larger display than the mobile device 200 (e.g. sent over a communication network or via a wired connection to the computing device) for analysis or a more detailed analysis of the application 212a executing on the mobile device 200, which may then present the performance analysis to the user on the larger screen of the second computing device. This provides the advantages of enhanced visualisation of the results of analysing the performance-related data, as well; large amounts of performance-related data may be stored on the computing device (e.g. a stand-a-lone personal computer).

Although the diagnostic application 216 and performance monitoring component 218 have been described, by way of example only, in relation to monitoring and retrieving performance-related data associated with an application 212a executing on the mobile device 200, it is to be appreciated by the skilled person that the diagnostic application 216 and/or performance monitoring component 218 may be further configured to implement, by way of example, a performance/adjustment feedback loop based on monitoring and retrieving performance-related data associated with one or more applications 212 and adjusting the operating point(s) of the hardware of the mobile device 200 based on parameters/statistics output from a performance analysis of the retrieved performance-related data to adaptively optimise the performance of the mobile device 200 and/or the one or more applications 212 executing on the mobile device 200.

FIG. 2c is a flow diagram illustrating an example process for a Java component 216a of diagnostic application 216 according to an embodiment, for example, the Java component 216a as described in relation to FIGS. 2a and 2b. The Java component 216a, which when executed on the processing unit 202 of the mobile device 200 has an application or sandbox level of permissions/privileges, and performs, by way of example, a process for monitoring and/or analysing (e.g. benchmarking) the performance of an application 212a for execution on the mobile device 200 based on the following:
C1. Listen for an instruction from the user to begin performance monitoring an application 212 for execution on mobile device 200. Proceed to C2.
C2. Receive the instruction to proceed with performance monitoring? If yes, then proceed to C3, otherwise proceed to C1.
C3. Instruct performance monitoring component 218 to proceed with performance monitoring of the application 212a. Proceed to C4.
C4. Instruct the native component, if necessary, to proceed with performance monitoring of the application 212a. Proceed to C5.
C5. Retrieve and store performance-related data that is configured to be accessible by the Java component 216a. For example, instantiated threads associated with each of retrieving performance-related data associated with CPU performance, GPU performance, battery usage performance, memory usage performance, and any other performance-related data suitable for retrieval and storage by the Java component 216a. Proceed to C6.
C6. Determine whether to continue to monitor performance of application 212a executing on mobile device 200 (e.g. user has indicated no more recording, the application 212a may have finished execution, enough performance-related data has been collected in relation to the application 212a, etc.). If it is determined to continue monitoring application proceed to C5, otherwise proceed to C7.
C7. Send terminate monitoring instruction/request to native component 216b and performance monitoring component 218. Proceed to C8.
C8. Perform at least one of the following:
   a) send stored performance-related data to another computing device or server for analysis of the application 212a executing on the mobile device 100 (e.g. send to a cloud system for analysis and/or presentation of results, or send to another computing device for analysis and presentation of results); and/or
   b) Analyse the stored performance-related data and present performance results of the application 212a executing on the mobile device 200 to the user of the mobile device 200; and/or
   c) Analyse the stored performance-related data to generate one or more usage parameters for the application 212a and storing in a usage profile for the application.
   Proceed to C1.

Although steps C6-C8 have been described above in a particular order, it is to be appreciated by the skilled person that the steps of C8 may be merged with C6, or be performed concurrently with the steps C5-C6. For example, instead of waiting to terminate the monitoring process etc. before performing step C8, step C8 may be performed prior to step C7. That is, step C6 may be modified to include: a) sending stored performance-related data to another computing device or server for analysis of the application 212a executing on the mobile device 100 (e.g. send to a cloud system for analysis and/or presentation of results, or send to another computing device for analysis and presentation of results); and/or analysing the stored performance-related data and present performance results of the application 212a executing on the mobile device 200 to the user of the mobile device 200; and/or analyse the stored performance-related data to generate one or more usage parameters for the application 212a and storing in a usage profile for the application. Thus performance statistics/parameters may be calculated during execution of the application 212a or applications 212 on the mobile device 200, which may be used in a feedback loop to optimise the performance of the mobile device 200.

FIG. 2d is a flow diagram illustrating an example process for a native component 216b of diagnostic application 216 according to an embodiment, for example, the native component 216b as described in relation to FIGS. 2a and 2b. The native component 216b, which when executed on the processing unit 202 of the mobile device 200 has an application or sandbox level of permissions/privileges, and performs, by way of example, a process for monitoring and/or analysing (e.g. benchmarking) the performance of an application 212a for execution on the mobile device 200 based on the following:
D1. Listen for an instruction from the Java component 216a to proceed with performance monitoring of an application 212a for execution on mobile device 200. Proceed to D2.
D2. Receive the instruction to proceed with performance monitoring? If yes, then proceed to D3, otherwise proceed to D1.
D3. Retrieve and store in storage unit 204 performance-related data that is configured to be accessible by the native component 216b. For example, instantiate threads associated with each of retrieving performance-related data associated with GPU performance and any other performance-related data suitable for retrieval and storage by the native component 216b. Proceed to D4.
D4. Determine whether instruction received from Java component 216a to terminate monitoring performance of application 212a executing on mobile device 200. If it is determined to continue monitoring application proceed to D3, otherwise proceed to D1.

FIG. 2e is a flow diagram illustrating an example process for a performance monitoring component 218 according to an embodiment, for example, the performance monitoring component as described in relation to FIGS. 2a and 2d. The performance monitoring component 218, which when executed on the processing unit 202 of the mobile device 200 has a shell level of permissions/privileges (e.g. ABD shell level of permissions/privileges), and performs, by way of example, a process for monitoring the performance of an application 212a for execution on the mobile device 200 based on the following:
E1. After the performance monitoring component 218 has launched, it is initialised and executes as a background process on the mobile device 200, and enters a wait state.
E2. Listen for an instruction from the Java component 216a to begin performance monitoring an application 212 for execution on mobile device 200. Proceed to E3.
E3. Determine whether a monitoring request/instruction for an application 212a to execute on mobile device 200 has been received from the Java component 216a. If a monitoring request/instruction has been received, then enter the monitoring state and proceed to E4, otherwise remain in the wait state and proceed to E2.
E4. Instruct Android Framework 214a to begin writing traces and enabling Linux kernel 214b of the Android OS 214 to activate trace functionality during execution of application 212a on the mobile device 200. For example, the performance monitoring component 218 may turn on or set certain flags in Android Framework 214a and Linux kernel 214b for performing debugging/trace functionality for outputting trace results as the application 212a executes on the mobile device 200. Proceed to E5.
E5. Measurement, retrieval and storage of performance-related data by filtering output of trace results for trace performance-related data (e.g. performance tags) associated with:
   a) some or all performance-related data accessible using either the shell level of permissions/privileges or the application/sandbox level of permissions/privileges;
   b) performance-related data (e.g. FPS, screen shots) only accessible using the shell level of permissions/privileges;
   c) performance-related data that is accessible using a shell level of permissions/privileges and which is inaccessible using application/sandbox level of permissions/privileges.
   Proceed to E6.
E6. Determine whether a terminate instruction/request to stop performance monitoring is received from the Java component 216a. If a terminate instruction/request is received then proceed to E7, otherwise proceed to E5.
E7. Terminate debugging/trace functionality of Android framework 214a and/or Linux kernel 214b. Proceed to E2.

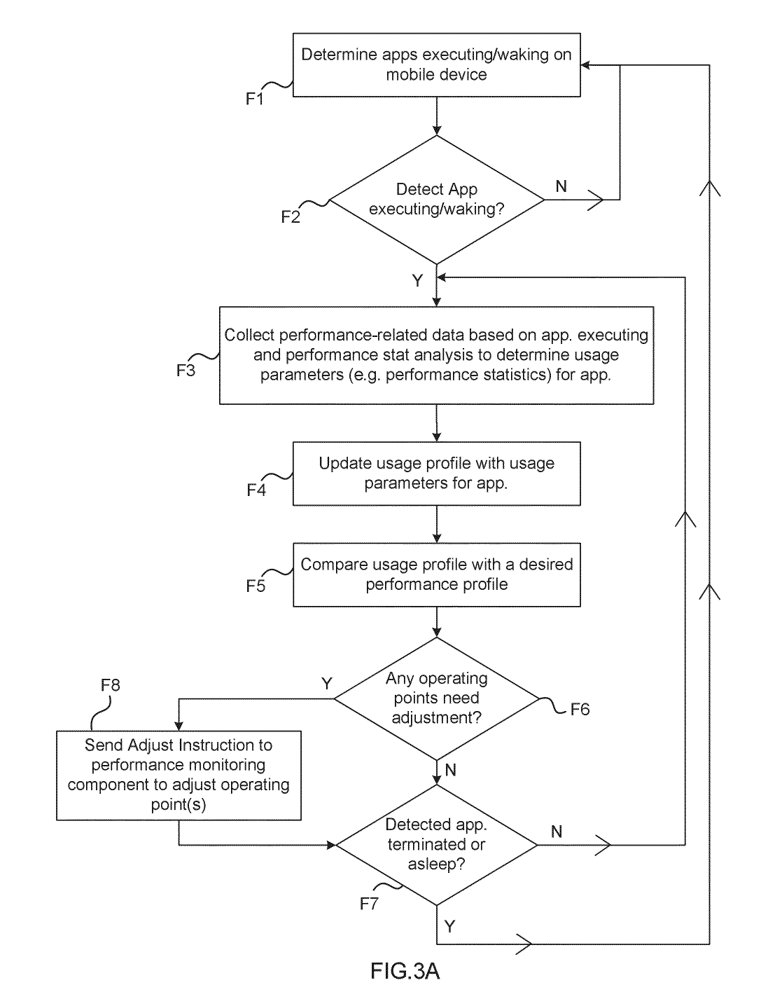

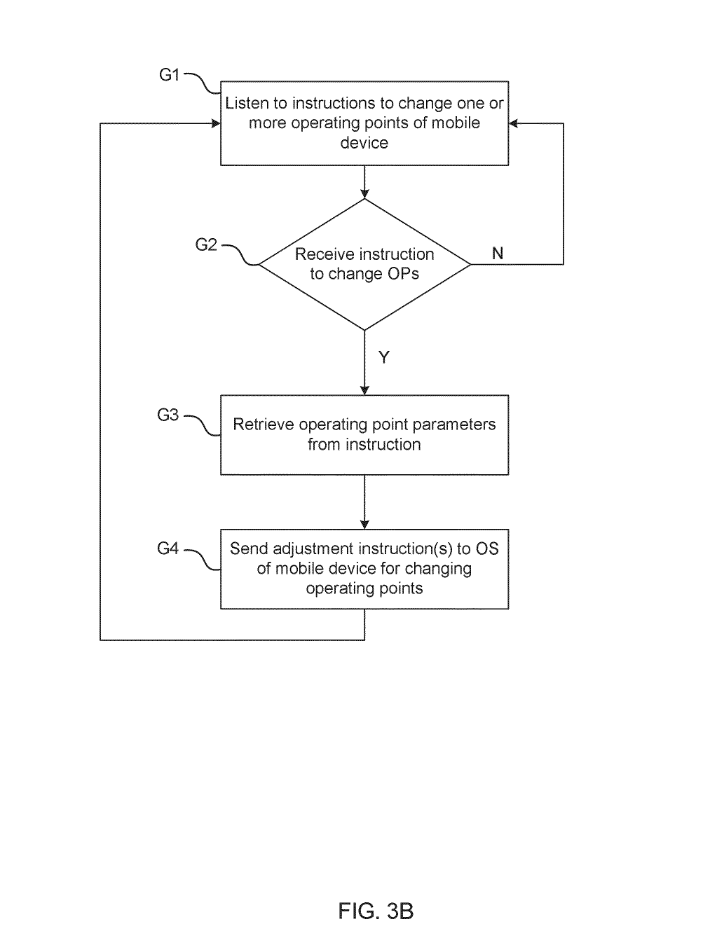

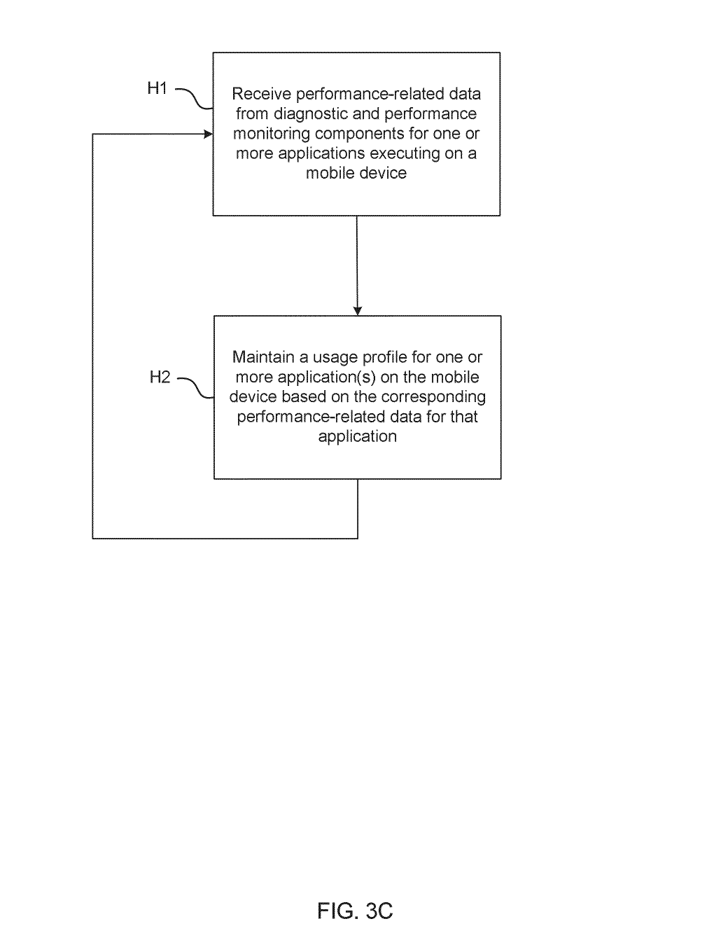

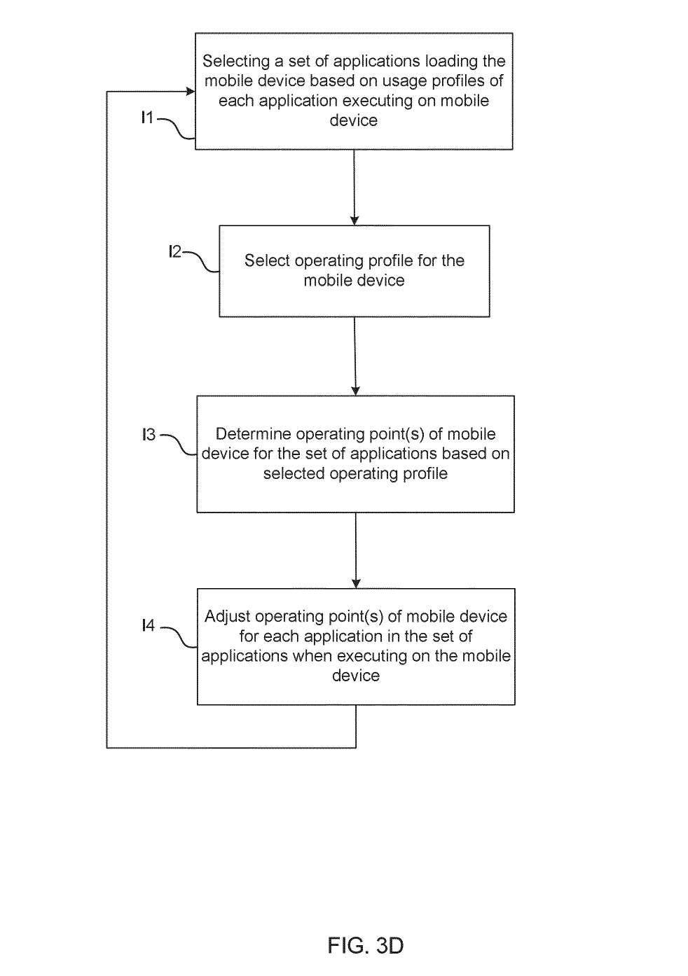

FIGS. 3a-3d illustrate flow diagrams for a process for monitoring and adjusting/optimising the operation of a mobile device according to embodiments based on performance-related data collected for an application while executing on the mobile device as described with reference to FIGS. 1a-2e. For simplicity, the reference numerals of FIGS. 1a-2e will be reused in FIGS. 3a-3d for identical or similar features, devices, components and/or applications. In addition to collecting and/or analysing performance-related data associated with one or more applications 112 or 212 executing on the mobile device 100 or 200, the diagnostic application 116 or 216 may be further configured to monitor (or profile) and adjust the operation of the mobile device 100 or 200 to enhance the performance of the mobile device 100 or 200 or user experience during execution of one or more applications 112 or 212 on the mobile device 100 or 200.

The components (e.g. diagnostic application 116 or 216 and performance monitoring component 118 or 218) for collecting performance-related data associated with each of the applications 112 and 212 may run as background processes on the mobile device 100 or 200 as a performance monitoring, analysis, and system optimization process. For example, the diagnostic application 116 or 216 may be configured to, while collecting the performance-related data, arrange for the collected performance-related data to be analysed as it is collected (e.g. analysed during collection of the performance-related data and during execution of the one or more applications 112 or 212). This allows the operating points of the mobile device 100 or 200 to be adjusted and optimized depending on the applications 112 or 212 executing on the mobile device 100 or 200. The components can be used to analyse the collected performance-related data and optimize the performance of the mobile device 100 or 200 or of the applications 112 or 212 executing on the mobile device 100 or 200. The performance monitoring, analysis and system optimization may be performed on the mobile device 100 or 200 without a continuous connection to a host/PC or a cloud-based service. Additionally or alternatively, should the mobile device 100 or 200 be connected to a server in a network (e.g. a cloud service) or a host/PC, the performance monitoring may be performed on the mobile device 100 or 200 with collected performance-related data being sent to the server in the network for analysis. The server or host/PC may then feedback results or performance statistics of the analysis and/or operating point adjustments to the mobile device 100 or 200 for performing optimization by adjusting the operating point(s) of the hardware/software of the mobile device 100 or 200. In any event, the mobile device 100 or 200 also becomes the monitoring and system optimization tool.

FIGS. 3a-3b illustrate flow diagrams for another example monitoring and adjustment process for optimising system performance using a feedback loop based on performance-related data collected for application(s) 112 or 212 executing on the mobile device 100 or 200. In this example, the diagnostic application 116 or 216 and performance monitoring component 118 or 218 may be configured to run in the background, in a “headless” manner in which a user interface may be suppressed and/or turned off. Alternatively, the diagnostic application 116 or 216 and performance monitoring component 118 or 218 may be configured to run in the background, in a “headless” manner with no user interface. In addition, the diagnostic application 116 or 216 may be configured to, while collecting and/or storing the performance-related data, arrange for the performance-related data to be analysed while it is collected (e.g. analysed during collection of the performance-related data and during execution of the one or more applications 112 or 212). The analysis may output a set of one or more performance statistics associated with the performance-related data and hardware/software of the mobile device 100 or 200. The performance statistics may be used to determine whether the mobile device 100 or 200 should be adjusted. That is, the performance statistics allow the operating points of the mobile device 100 or 200 to be analysed/compared against a selected operating profile and adjusted/optimized depending on the applications 112 or 212 executing on the mobile device 100 or 200.

Referring to FIG. 3a, the diagnostic application 116 or 216 as described with reference to FIGS. 1a to 2e may be further configured to perform the following monitoring and adjustment process (for each application, some of the below method steps may be performed concurrently):
F1. Determine one or more applications executing on the mobile device or one or more applications waking up from a sleep/hibernation state on mobile device. Proceed to F2.
F2. Detect an application executing/waking on mobile device? If an application is detected to have initiated execution on mobile device or is waking from a sleep state, then proceed to F3. Otherwise proceed to F1.
F3. Collect performance-related data associated with execution of the detected application on mobile device 100 or 200 and perform a statistical analysis to determine performance-related parameters/statistics (e.g. usage statistics) for the detected application. Proceed to F4.
F4. Periodically update a usage profile for the detected application with the performance-related parameters/statistics. Proceed to F5.
F5. Compare the updated usage profile for the detected application with a desired performance profile for the mobile device or the application executing on the mobile device. Proceed to F6.
F6. Determine whether any operating points of hardware/software of the mobile device 100 or 200 are to be adjusted based on the comparison? If it is determined that one or more operating points of the mobile device should be updated, then proceed to F8. Otherwise, proceed to F7.
F7. Has the detected application terminated execution or returned to a sleep/wait state (e.g. the user is not currently using the application, but it is executing in the background)? If the application has terminated execution or has moved to a sleep/wait state, then proceed to F1. Otherwise, proceed to F3.
F8. Send adjustment instruction to the performance monitoring component 118 or 218 for changing the one or more operating points of the mobile device 100 or 200. Proceed to F7.

Step F3 may further include the diagnostic application 116 or 216 and/or performance monitoring component 118 or 218 as described with reference to FIGS. 1a-2e being configured to retrieve and provide performance-related data while the detected application is executing on the mobile device 100 or 200. The statistical analysis may be performed on the mobile device 100 or 200, or by a server (e.g. a cloud service) or other computing device, where the performance-related usage statistics/parameters are output as described with reference to FIGS. 1a-2e and 4a-4f.

Referring to FIG. 3b, the performance monitoring component 118 or 218 as described with reference to FIGS. 1a to 2e may be further configured to perform the following adjustment process for each application:
G1. Listen for instructions associated with adjusting the operating point of the mobile device 100 or 200. Proceed to G2.
G2. Receive adjustment instructions? If yes, then proceed to G3. Otherwise, proceed to G1 and continue listening for adjustment instructions.
G3. Retrieve the operating point parameter adjustments from the adjustment instructions. Proceed to G4.
G4. Send instructions associated with the adjustment instructions and operating point parameter adjustments to the OS 114 or 214 of the mobile device 100 or 200 for changing the one or more operating points of the mobile device 100 or 200. Proceed to G1.

As described with reference to FIGS. 1a-2d, the Linux trace pipe can be used for measuring a host of performance-related data and parameters that can give vital statistics about the mobile device 100 or 200 and the resource consumption when applications execute on the mobile device 100 or 200. The performance-related data estimated from the trace pipe can be analysed/converted to provide performance-related statistics/parameters that may be used to control the operating points of the underlying hardware/different components of the mobile device 100 or 200. For example, one or more chips of the processing unit 102 or 202 may be adjusted based on the performance-related statistics of the CPU performance-related data associated with execution of an application on the mobile device 100 or 200.

In another example, the operating point of the mobile device 100 or 200 may be adjusted for more performance when the user executes a gaming application (e.g. a graphics intensive game) that may require a high performance on the mobile device 100 or 200. When the user plays the gaming application on the mobile device, the diagnostic application 116 or 216 is further configured to determine, based on performance-related data being collected during execution of the gaming application, whether the performance of the game on the mobile device 100 or 200 is acceptable or meets certain performance criteria in relation to the user playing the game. If it is detected that the mobile device 100 or 200 is not able to achieve a frame rate of more than 30 frames-per-second, then this information is fedback to the underlying hardware, e.g. the GPU driver, and corrective action may be taken to adjust the clock speed of the GPU higher. This will increase the performance of the game and provide a better user experience whilst the user plays the game.

In a further example, the operating point of the mobile device 100 or 200 may be adjusted to optimize power consumption when a user executes an application (e.g. a game) on the mobile device 100 or 200. As the user plays the game on the mobile device 100 or 200, the diagnostic application 116 or 216 is further configured to determine, based on performance-related data being collected during execution of the application, whether the performance of the game on the mobile device 100 or 200 is consuming the battery at a rate that is acceptable to the further operation of the mobile device 100 or 200. If it is detected that the rate of battery consumption of the mobile device 100 or 200 is too high, then this information feedback to the underlying hardware, e.g. the GPU driver and CPU clocking modules and corrective action may be taken to adjust the operation of the GPU/CPU to minimize battery consumption.

Thus, the diagnostic application 116 or 216 may be further configured to monitor a set of the one or more applications 112 or 212 when executing on the mobile device 100 or 200, and feeding back adjustments to the operating point of the mobile device 100 or 200 to enhance the user experience when using the one or more applications 112 or 212. As each application 112a or 212a is to be monitored for execution on mobile device 100 or 200, the diagnostic application 116 or 216 and performance monitoring component 118 or 218 are configured to retrieve and collect performance-related data during execution of each of the applications 112 or 212 when they execute on the mobile device. The statistics of the performance-related data for each application executing on the mobile device 100 or 200 is analysed and stored in a usage profile associated with the application. The usage profile may store parameters associated with statistics of performance-related data associated with execution of the application. The historical usage data for each application may also be stored.

In steps F3-F5, a statistical analysis of the performance-related data associated with execution of the application is used to determine vital system parameters or usage parameters for the application that may be compared with the operating point of the mobile device 100 or 200, which may be adjusted according to a desired performance profile for the application or the mobile device 100 or 200 (e.g. increasing/decreasing CPU clock speeds, increasing/decreasing power/battery consumption, increasing/decreasing memory usage or consumption, etc.)

For example, performance-related data such as, by way of example only, CPU, battery/power consumption, GPU, memory consumption/usage, frames-per-second data, and screen shot data may be statistically analysed to get the a set of performance-related statistical parameters or performance statistics such as average, maximum, minimum, and/or median CPU clock speeds, battery/power consumption, voltage, temperature, GPU performance, memory consumption/usage, and frame rate data parameters. The performance-related statistics may include the performance statistics as described with reference to FIGS. 1a-2e and 4a-4f. For example, CPU performance statistics, battery performance statistics, GPU performance statistics, FPS performance statistics, screenshot performance statistics, memory performance statistics, usage time statistics etc, and any other performance statistic/parameter that may be output from an analysis of the performance-related data associated with the application(s) 112 or 212 executing on the mobile device 100 or 200. This data may be compared with a previous usage profile of the application 112a or 212a and/or optimal or desired usage profile for the application 112a or 212a and/or a set of performance profiles for the mobile device 100 or 200.

In another example, a desired performance profile may be an optimal usage profile for the application 112a or 212a may be a set or parameters based on the application developer's minimum/maximum hardware configuration or settings of the mobile device 100 or 200 that provide the best user experience when the application 112a or 212a executes on the mobile device 100 or 200. As another example, a desired performance profile may be a set of parameters based on the user's desired or chosen hardware configuration and/or settings of the mobile device 100 or 200 when executing the application 112a or 212a on the mobile device 100 or 200. As a further example, the mobile device 100 or 200 may also have a desired performance profile based on set of performance profiles each associated with a set of parameters corresponding to various hardware configurations or settings. Examples of performance profiles of the mobile device 100 or 200 may be: a) a maximum performance profile that optimises the hardware settings of the mobile device 100 or 200 for maximum possible execution performance of the application 112a or 212a; b) maximum possible display rate for the application 112a or 212a; and/or c) a minimum power/battery consumption or economy performance profile. Such performance profiles may also be user defined.

FIGS. 3c-3d illustrate flow diagrams for another example monitoring and adjustment process for optimising system performance using a feedback loop based on performance-related data collected for application(s) 112 or 212 executing on the mobile device 100 or 200. In this example, the diagnostic application 116 or 216 and performance monitoring component 118 or 218 may be configured to run in the background, in a “headless” manner in which a user interface may be suppressed and/or turned off. Alternatively, the diagnostic application 116 or 216 and performance monitoring component 118 or 218 may be configured to run in the background, in a “headless” manner with no user interface. In addition, the diagnostic application 116 or 216 may be configured to, while collecting and/or storing the performance-related data, arrange for the performance-related data to be analysed while it is collected (e.g. analysed during collection of the performance-related data and during execution of the one or more applications 112 or 212). The analysis may output a set of one or more performance statistics associated with the performance-related data and hardware/software of the mobile device 100 or 200. The performance statistics may be used to determine whether the mobile device 100 or 200 should be adjusted. That is, the performance statistics allow the operating points of the mobile device 100 or 200 to be analysed/compared against a selected operating profile and adjusted/optimized depending on the applications 112 or 212 executing on the mobile device 100 or 200.

Referring to FIG. 3c, the diagnostic application 116 or 216 as described with reference to FIGS. 1a to 3b may be further configured to perform the following monitoring process (for each application, some of the below method steps may be performed concurrently):
H1. Receive performance-related data from components of the diagnostic application 116 or 216 and/or performance monitoring component 118 or 218 for one or more applications executing on the mobile device 100 or 200. Proceed to H2.
H2. Maintain a usage profile for each application on the mobile device 100 or 200 based on the corresponding performance-related data for that application. Proceed to H1.

Step H1 may include the diagnostic application 116 or 216 and/or performance monitoring component 118 or 218 as described with reference to FIGS. 1a-2e being configured to retrieve and provide performance-related data for the one or more applications executing on the mobile device 100 or 200. The statistical analysis may be performed on the mobile device 100 or 200, or by a server (e.g. a cloud service) or other computing device, where usage parameters such as performance statistics/parameters or usage statistics are output as described with reference to FIGS. 1a-3b and 4a-4f.

Steps H1 and H2 describe a process that may be considered to be a learning phase to determine the usage patterns of the applications 112 or 212 on the mobile device 100 or 200. The usage profile(s) for each of the applications 112 or 212 on the mobile device 100 or 200 may be stored and maintained in a database, a table or other suitable data structure. During this learning phase the diagnostic application 116 or 216 will determine the usage patterns of how the applications 112 or 212 are used on the mobile device 100 or 200. For example, the usage profile of each of the applications 112 or 212 may comprise one or more usage parameters that may include, but are not limited to, performance and/or usage statistics (e.g. performance-related statistics) determined from the performance-related data received.

The performance and/or usage statistics may include the performance statistics as described with reference to FIGS. 1a-3b and 4a-4f. For example, CPU performance statistics, battery performance statistics, GPU performance statistics, FPS performance statistics, screenshot performance statistics, memory performance statistics, usage time statistics etc., and any other performance and/or usage statistic/parameter that may be output from an analysis of the performance-related data associated with the application(s) 112 or 212 executing on the mobile device 100 or 200.

For example, the usage parameters for each application may include at least one or more of the following: usage time of each application; usage of the CPU by each application (e.g. CPU performance statistics); usage of the GPU by each application (e.g. GPU performance statistics); usage of the battery (e.g. battery performance statistics); usage of the memory by each application (e.g. memory performance statistics); maximum and/or minimum and/or average/median FPS determined for each application (e.g. FPS performance statistics); usage parameters and/or performance statistics as described in relation to FIGS. 1a to 3b and 4a-4f; and/or other performance-related statistics/usage determined for each application from the performance-related data. For example, a usage table for the applications 112 or 212 on the mobile device 100 or 200 may be created and maintained in which each usage profile of an application 112a or 212a on the mobile device 100 or 200 forms a row of the table with one or more columns representing one or more usage parameters (e.g. usage times, etc.).

For each application 112a or 212a executing on the mobile device 100 or 200, the performance-related data that is gathered is used to update the usage parameter(s) for the corresponding usage profile for that application 112a or 212a. This may involve the diagnostic application 116 or 216 analysing the performance-related data gathered/measured to provide the usage parameter(s), or simply storing the performance-related data as a usage parameter etc.

In addition to collecting and maintaining the usage profile(s) of the application(s) 112 or 212 of the mobile device 100 or 200, the diagnostic application 116 or 216 may be configured to analyse the usage profiles of the application to determine whether to adjust one or more operating points of the mobile device 100 or 200 and instruct the performance monitoring component 118 or 218 to adjust the determined operating point(s) as described.

Referring to FIG. 3d, in addition to the diagnostic application 116 or 216 monitoring each application 112a and 212a and maintaining a usage profile for each application 112a or 212a on the mobile device 100 or 200 as described with reference to FIG. 3c, the diagnostic application 116 or 216 and/or the performance monitoring component 118 or 218 as described with reference to FIGS. 1a to 3c may be further configured to perform the following adjustment and control process, which may be performed concurrently with the monitoring processes as described with reference to FIGS. 1a to 3c:
I1. Select a set of applications loading the mobile device 100 or 200 based on a usage profile of each application executing on the mobile device 100 or 200. For example, the usage profile of each application may be maintained as described with reference to FIG. 3c. Proceed to I2.
I2. Select an operating profile from a set of operating profiles for the mobile device 100 or 200. For example, the operating profile may be based on those as described with reference to FIGS. 3a-3c. Proceed to I3.
I3. Determine operating point(s) of the hardware/software of the mobile device 100 or 200 for the set of applications loading the mobile device 100 or 200 based on the selected operating profile. Proceed to I4.
I4. Adjust the operating point(s) of the mobile device 100 or 200 for each application 112a or 212a in the set of applications when executing on the mobile device 100 or 200. Proceed to I1.

In step I1, the set of applications loading the mobile device 100 or 200 may be those applications executing on the mobile device 100 or 200 that are mostly using the resources of the mobile device 100 or 200. For example, the selected set of applications loading the mobile device may be based on analysing the usage profile for each application executing on the mobile device 100 or 200, and selecting those applications having usage profiles that exceed or meet one or more usage parameter thresholds, conditions or rules, or selecting the n top most applications having usage profiles that exceed or meet one or more usage parameter thresholds, conditions or rules. For example, a rule may be set to select the n top most applications with the highest usage time (e.g. the top most 3 applications with the highest usage time), or a threshold and rule combination may be used to select the n top most applications with a CPU usage time exceeding 50%. Other thresholds, rules and conditions may be used to select a number of one or more applications that are loading or affecting the mobile device 100 or 200 based on their usage (e.g. highest usage time, highest CPU usage or highest FPS etc.) of the resources of the mobile device 100 or 200.

In step I2, the diagnostic application 116 or 216 may also determine an operating profile from a set of operating profiles for the mobile device 100 or 200. The set of operating profiles may include, but is not limited to, a power saving mode, a performance enhancing mode, or any other operating profile. In step I3, the operating point(s) of the mobile device 100 or 200 may be determined based on the usage profiles of the set of applications loading the mobile device taking into account the selected operating profile of the mobile device.

In step I4, the diagnostic application 116 or 216 and/or performance monitoring component 118 or 218 may be configured to adjust the operating point(s) of the hardware and/or software of the mobile device 100 or 200. For example, the diagnostic application 116 or 216 may be configured to instruct the performance monitoring component 118 or 218 accordingly, or in a similar fashion as described with respect to FIGS. 3a and 3b. The performance monitoring component 118 or 218 may be configured to control the operating points of the mobile device 100 or 200 by operating the hardware of the mobile device 100 or 200 to conform to the selected operating profile and/or the operating point(s), (e.g. a power saving mode or a performance enhancing mode). For example, the performance monitoring component 118 or 218 may be configured to send control instructions to the OS 114 or 214 of the mobile device 100 or 200 for adjusting the operating points of the hardware underlying mobile device 100 or 200 to conform to the selected operating profile and/or the operating point(s), (e.g. a power saving mode or a performance enhancing mode). The OS 114 or 214 then operates to adjust the operating points of the hardware of the mobile device 100 or 200. For example, in the power saver mode, the performance monitoring component 118 or 218 may be configured to clock down the processors 102 or 202 to save power when the user interacts with the selected set of applications in the usage table. In a performance enhancing mode, the performance monitoring component 118 or 218 may be configured to enhance the performance by clocking up the processors 102 or 202 of the mobile device 100 or 200 for the selected set of applications.

Additionally, referring to FIGS. 3c and 3d, in steps H1 and H2, the diagnostic application 116 or 216 may use the selected set of applications from step I1 to monitor the performance of only those applications in the set of applications loading the mobile device 100 or 200, instead of monitoring all applications executing on the mobile device. This means that only the usage profiles of the set of applications loading the mobile device 100 or 200 are maintained and used to adjust the operating point(s) if the mobile device 100 or 200. For the remaining applications, which may be infrequently used or are determined not to substantially load the mobile device 100 or 200, the diagnostic application 116 or 216 may be inactive in monitoring the performance of these applications until these applications start to load the mobile device 100 or 200.

Alternatively or additionally, referring to FIGS. 3c and 3d, the diagnostic application 116 or 216 may be configured to determine the processor 102 or 202 usage times of each of the applications executing on the mobile device 100 or 200, where steps H1 and H2 may be further adapted to include receiving performance-related data and maintaining usage profiles of a subset of applications, instead of receiving performance-related data and maintaining the usage profiles for all applications executing and/or installed on the mobile device 100 or 200. For example, the usage times of applications executing on the mobile device 100 or 200 may be ranked such that m applications can be selected for monitoring, receiving performance-related data, and maintaining the corresponding user profiles in accordance with FIGS. 3c and 3d. This subset of applications may also be considered as the set of applications loading the mobile device 100 or 200 as described in step I1. For example, the m applications may be selected from those having the highest usage or a usage time above a certain threshold, or those applications with the highest usage times that combine to form a certain percentage threshold (e.g. 90% usage of the processor). Alternatively, the subset of applications may correspond to the set of applications loading the mobile device 100 or 200 as described with reference to step I1. Although several examples of selecting the m applications have been provided, it is to be appreciated by the skilled person that the subset of applications or the m applications may be selected in any other suitable way. This means that only the usage profiles of the subset of applications executing on the mobile device 100 or 200 maintained for use in adjusting the operating point(s) of the mobile device 100 or 200.

In this way, the diagnostic application 116 and 216 and the performance monitoring component 118 or 218 perform an adaptive and intelligent control of the operating points of the underlying hardware of the mobile device 100 or 200, which adapts to the users usage of the applications on the mobile device.

The systems. methods and apparatus described above may be implemented at least in part in computer software. Those skilled in the art will appreciate that the apparatus described above may be implemented using general purpose computer equipment or using bespoke equipment. The different components of the systems may be provided by software modules executing on a computer.

The hardware elements, operating systems and programming languages of such computers are conventional in nature, and it is presumed that those skilled in the art are adequately familiar therewith. In an embodiment the server may be centrally located and the clients are distributed. In other embodiments, the server functions may be implemented in a distributed fashion on a number of similar platforms, to distribute the processing load.

Here, aspects of the methods and apparatuses described herein can be executed on a computing device such as a server. Program aspects of the technology can be thought of as “products” or “articles of manufacture” typically in the form of executable code and/or associated data that is carried on or embodied in a type of machine readable medium. “Storage” type media include any or all of the memory of the computers, processors or the like, or associated modules thereof, such as various semiconductor memories, tape drives, disk drives, and the like, which may provide storage at any time for the software programming. All or portions of the software may at times be communicated through the internet or various other telecommunications networks. Such communications, for example, may enable loading of the software from one computer or processor into another computer or processor. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible non-transitory “storage” media, terms such as computer or machine “readable medium” refer to any medium that participates in providing instructions to a processor for execution.

Hence, a machine readable medium may take many forms, including but not limited to, a tangible storage carrier, a carrier wave medium or physical transaction medium. Non-volatile storage media include, for example, optical or magnetic disks, such as any of the storage devices in computer(s) or the like, such as may be used to implement the encoder, the decoder, etc. shown in the drawings. Volatile storage media include dynamic memory, such as the main memory of a computer platform. Tangible transmission media include coaxial cables; copper wire and fiber optics, including the wires that comprise the bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will appreciate that while the foregoing has described what are considered to be the best mode and, where appropriate, other modes of performing the invention, the invention should not be limited to specific apparatus configurations or method steps disclosed in this description of the preferred embodiment. It is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings. Those skilled in the art will recognize that the invention has a broad range of applications, and that the embodiments may take a wide range of modifications without departing from the inventive concept as defined in the appended claims.

Although the present invention has been described in terms of specific exemplary embodiments, it will be appreciated that various modifications, alterations and/or combinations of features disclosed herein will be apparent to those skilled in the art without departing from the scope of the invention as set forth in the following claims.

1. A computer-implemented method for monitoring performance of a mobile device, the mobile device comprising a memory and a processor, the memory including computer readable instructions stored thereon associated with a diagnostic application, which when executed on the processor, has a first level of permissions for accessing the mobile device, and a performance monitoring component, which when executed on the processor, has a second level of permissions for accessing the mobile device, the method comprising:
at the diagnostic application on the mobile device:
sending a monitoring request to the performance monitoring component to retrieve performance-related data associated with execution of an application on the mobile device, wherein the performance-related data is accessible using the second level of permissions;
receiving and storing performance related data from the performance monitoring component for analysing the performance of the mobile device executing the application;
at the performance monitoring component on the mobile device:
receiving the monitoring request from the diagnostic application to retrieve the performance-related data associated with the mobile device;
monitoring and storing the performance-related data accessible with second level of permissions of the mobile device during execution of the application; and
sending the performance-related data to the diagnostic application for analysing the performance of the mobile device executing the application.

2. A method as claimed in claim 1, wherein the mobile device has a plurality of applications stored thereon and the diagnostic application further comprising selecting one or more applications of the plurality of applications to be monitored for execution on mobile device.

3. A method as claimed in claim 1, the diagnostic application further comprising sending a monitoring request to the performance monitoring component to retrieve performance-related data associated with execution of an application on the mobile device, wherein the performance-related data is inaccessible using the first level of permissions.

4. A method as claimed in claim 1, the diagnostic application further comprising retrieving performance-related data associated with execution of an application on the mobile device that is accessible with the first level of permissions.

5. A method as claimed in claim 1, further comprising instantiating the diagnostic application to execute as a background process on the mobile device.

6. A method as claimed in claim 1, further comprising instantiating the performance monitoring component on the mobile device from a second mobile device coupled to the mobile device using at least a second level of permissions.

7. A method as claimed in claim 1, further comprising instantiating the performance monitoring component on the mobile device during start-up of the mobile device.

8. A method as claimed in claim 1, the monitoring and storing of performance-related data by the performance monitoring component further comprising:
activating a trace function associated with an operating system of the mobile device, the trace function for outputting trace data;
scanning the trace data for trace performance data associated with the performance-related data;
storing and sending the trace performance data to the diagnostic application;

9. A method as claimed in claim 1, wherein sending performance-related data to the diagnostic application further comprising, for each type of performance-related data, periodically sending said each type performance-related data to the diagnostic application.

10. A method as claimed in claim 9, wherein scanning the trace data further comprising periodically scanning the trace data for trace performance data.

11. A method as claimed in claim 1, wherein the performance-related data accessible with second level of permissions includes at least one from the group of:
performance-related data associated with screenshots of the mobile device;
performance-related data associated with frames per second of a display of the mobile device;
performance-related data associated with one or more central processing unit(s) of the processor of the mobile device;
performance-related data associated with power or battery consumption of the mobile device;
performance-related data associated with one or more graphical processing units of the mobile device;
performance-related data associated with memory or storage consumption of the mobile device; and
any other performance-related data associated with the mobile device that is accessible with second level of permissions.

12. A method as claimed in claim 4, wherein the performance related data accessible with first level of permissions includes at least one from the group of:
performance-related data associated with one or more central processing unit(s) of the processor of the mobile device;
performance-related data associated with power or battery consumption of the mobile device;
performance-related data associated with one or more graphical processing units of the mobile device;
performance-related data associated with memory or storage consumption of the mobile device; and
any other performance-related data associated with the mobile device that is accessible with first level of permissions.

13. A method as claimed in claim 1, the diagnostic application further comprising transmitting the performance-related data over a communications network to one or more servers for analysing the performance of the mobile device.

14. A method as claimed in claim 1, wherein the mobile device has an operating system comprising components associated with Android Frameworks and a Linux Kernel, the first level of permissions is an application level of permissions and the second level of permissions is a shell level of permissions, the monitoring and storing of performance-related data by the performance monitoring component further comprising:
activating a debugging function associated with the Android Frameworks to output debugging information associated with execution of the application on the mobile device;
activating a trace function associated with the Linux Kernel component, the trace function for receiving debugging information and generating a trace pipe of for outputting trace data;
scanning the trace data for trace performance data associated with the performance-related data;
storing the trace performance data; and
sending the trace performance data to the diagnostic application.

15. A method as claimed in claim 1, further comprising adjusting one or more operating points of the mobile device according to a usage profile comprising one or more usage parameters for the application determined from the analysis of performance-related data associated with the application.

16. A method as claimed in claim 15, the step of adjusting one or more operating points of the mobile device further comprising:
collecting and maintaining the one or more usage parameters in the usage profile of the application based on the performance-related data associated with execution of the application on the mobile device;
determining adjustments to one or more operating points of the mobile device based on the one or more usage parameters and the current state of the mobile device; and
adjusting one or more of the operating points of the mobile device.

17. A method as claimed in claim 16, wherein determining adjustments includes at least one from the group of:
determining to adjust one or more operating points of the mobile device to minimise power or battery consumption based on the usage profile;
determining to adjust one or more operating points of the mobile device to maximise processing power based on the usage profile;
determining to adjust one or more operating points of the mobile device to minimise processing power based on the usage profile and the application type; and
determining to adjust one or more operating points of the mobile device by comparing a selected performance profile for the mobile device with the usage profile for the application.

18. A method as claimed in claim 1, further comprising:
maintaining usage profile(s) for one or more applications on the mobile device based on performance-related data associated with the one or more applications;
selecting a set of applications loading the mobile device based on one or more usage profile(s) of the one or more application(s);
determining adjustments to one or more operating point(s) of the mobile device for the set of applications based on an operating profile for the mobile device;
adjusting the operating point(s) of the mobile device for each application in the set of applications when executing on the mobile device.

19. A method as claimed in claim 18, wherein maintaining usage profile(s) for one or more applications further comprises maintaining usage profile(s) associated with applications in the set of applications loading the mobile device.

20. A computer-implemented method for monitoring performance of a mobile device, the mobile device comprising a memory and a processor, the memory including computer readable instructions stored thereon associated with a performance monitoring component, which when executed on the processor, has a shell level of permissions for accessing the mobile device, the method, performed on the mobile device, comprising:
sending a monitoring request to the performance monitoring component to retrieve performance-related data associated with execution of an application on the mobile device, wherein the performance-related data is accessible using shell level of permissions; and
receiving and storing performance related data from the performance monitoring component for analysing the performance of the mobile device executing the application.

21. A computer-implemented method for monitoring performance of a mobile device, the mobile device comprising a memory and a processor, the memory including computer readable instructions stored thereon associated with a diagnostic application, which when executed on the processor, has an application level of permissions for accessing the mobile device, the method, performed on the mobile device, comprising:
receiving a monitoring request from the diagnostic application to retrieve performance-related data associated with an application for execution the mobile device, the performance-related data being accessible using shell level of permissions;
monitoring and storing the performance-related data accessible with shell level of permissions of the mobile device during execution of the application; and
sending the performance-related data to the diagnostic application for analysing the performance of the mobile device executing the application.
